(19) United States
(12) Patent Application Publication
(10) Pub. No.: US 2026/0120151 A1
(43) Pub. Date: Apr. 30, 2026

(54) ADVERTISEMENT GENERATION METHOD AND RELATED DEVICE

(71) Applicant: Huawei Technologies Co., Ltd., Shenzhen (CN)

(72) Inventors: Yue Wang, Xi'an (CN); Mingxing Duanmu, Xi'an (CN); Weicai Zhong, Shenzhen (CN)

(21) Appl. No.: 19/433,333

(22) Filed: Dec. 26, 2025

Related U.S. Application Data
(63) Continuation of application No. PCT/CN2024/101418, filed on Jun. 25, 2024.

(30) Foreign Application Priority Data
Jun. 30, 2023 (CN) 202310809750.2

(51) Int. Cl. G06Q 30/0241; G06F 3/04847; G06F 3/0486; G06Q 30/0251

(52) U.S. Cl. CPC G06Q 30/0276; G06F 3/04847; G06F 3/0486; G06Q 30/0253; G06Q 30/0277

(57) ABSTRACT

An advertisement generation method and a related device, wherein when a correct delivery intention is missing in an advertisement picture-copy, a delivery intention-related element may be embedded in an advertisement picture, and an expression of the delivery intention-related embedded element is reflected in an advertisement copy. In addition, when an incorrect/interfering delivery intention exists in the advertisement picture-copy, an element related to the correct delivery intention may be embedded in the advertisement picture, an element related to the incorrect/interfering delivery intention may be covered or removed, a related expression of the incorrect/interfering delivery intention in the advertisement copy may be further removed, and an expression of the element related to the correct delivery intention may be embedded in the advertisement copy.

### CROSS-REFERENCE TO RELATED APPLICATIONS

This application is a continuation of International Application No. PCT/CN2024/101418, filed on Jun. 25, 2024, which claims priority to Chinese Patent Application No. 202310809750.2, filed on Jun. 30, 2023. The disclosures of the aforementioned applications are hereby incorporated by reference in their entireties.

### TECHNICAL FIELD

This application relates to the field of terminal technologies, and in particular, to an advertisement generation method and a related device.

### BACKGROUND

Conversion guidance missing is an important factor that causes a low conversion rate of advertisement delivery. Before the advertisement delivery, an advertiser generally specifies a specific user operation (for example, tap or download) that is valuable to a business of the advertiser. An advertisement delivery platform charges, based on the specified user operation, the advertisement delivered by the advertiser.

However, many advertisers generally ignore conversion guidance in creative designs of advertisements, resulting in the low conversion rate of the advertisement delivery.

### SUMMARY

Embodiments of this application provide an advertisement generation method and a related device, which are applicable to a plurality of advertisement delivery scenarios, and can effectively improve a conversion rate of advertisement delivery.

According to a first aspect, an embodiment of this application provides an advertisement generation method, applied to a terminal device. The method includes: the terminal device displays a first advertisement in a first user interface, where the first advertisement does not include a first interface element; the terminal device detects a first user operation in the first user interface; the terminal device obtains a first delivery intention of the first advertisement in response to the first user operation; and the terminal device displays a second advertisement in the first user interface, where the second advertisement is generated by embedding the first interface element in the first advertisement, the first interface element is determined based on the first delivery intention, and the first interface element is used to receive a second user operation.

The first user interface may be an interactive interface (for example, a user interface 410 illustrated in FIG. 4B) used to implement a function like displaying or editing an advertisement. The first advertisement may be an advertisement before editing (namely, an original advertisement, for example, an advertisement shown in FIG. 4H). The second advertisement may be an advertisement generated after the first advertisement is edited (namely, a new advertisement, for example, an advertisement shown in FIG. 4I). The first interface element may be an element (for example, a picture control, a word control, a form control, or an icon control) related to the first delivery intention. The first delivery intention may be a delivery intention specified by an advertiser. The first user operation may include an operation of setting a delivery intention (for example, a delivery intention like wake-up, next-day retention, payment, activation, registration, a form, or customization) by a user (for example, the advertiser or an advertisement designer entrusted by the advertiser) (for example, an operation that is shown in FIG. 4C and that is of selecting the form delivery intention by the user), and may further include an operation of setting a system function (for example, a system function like delivery intention embedding, delivery intention correction, or delivery intention extraction) by the user (for example, an operation that is shown in FIG. 4E and that is of selecting the delivery intention embedding system function). The second user operation may be an operation performed by a user (for example, a user watching the advertisement, for example, a consumer) on the first interface element when the second advertisement is played. In other words, the first interface element may be used to receive a user operation.

In this application, the advertisement (which may also be referred to as an advertisement picture-copy) may include both an advertisement picture and an advertisement copy, or the advertisement may include only the advertisement picture or the advertisement copy.

Through implementation of the method provided in the first aspect, when a correct delivery intention (namely, the delivery intention specified by the advertiser) is missing in the advertisement, an element related to the correct delivery intention can be embedded in the advertisement picture. In this way, the correct delivery intention of the advertisement can be effectively conveyed, and a conversion rate of advertisement delivery can be improved.

In a possible implementation, the terminal device stores a first advertisement material library, and the first interface element is obtained from the first advertisement material library.

The first advertisement material library may be, for example, an advertisement material library that is shown in FIG. 4H and that is displayed in an advertisement material display and interaction area. The first interface element may be obtained from the first advertisement material library.

In this way, when an element related to a delivery intention needs to be obtained, one or more elements related to the delivery intention can be searched for from the first advertisement material library. When a plurality of elements are found, an element may be selected according to a preset rule and embedded in the original advertisement to generate the new advertisement.

In a possible implementation, the first interface element includes any one of the picture control, the word control, the form control, and the icon control.

The first interface element may be a control that can receive the user operation, and may include but is not limited to the picture control, the word control, the form control, and the icon control.

In this way, when the advertisement includes an element related to the delivery intention specified by the advertiser, the user can perform, on the element, a specific operation (for example, an operation like tap, download, or filling in information) that is valuable to a business of the advertiser, so that the conversion rate of the advertisement delivery can be improved.

In a possible implementation, the first delivery intention includes any one of the wake-up, the next-day retention, the payment, the activation, the registration, the form, and the customization.

The first delivery intention may include but is not limited to delivery intentions such as the wake-up, the next-day retention, the payment, the activation, the registration, the form, and the customization.

In this way, the advertiser can specify different delivery intentions, to receive a specific operation that is performed by the user and that is valuable to different businesses of the advertiser.

In this application, the delivery intention may mean that, when the terminal device plays the advertisement, the specific operation that is performed by the user and that is valuable to the business of the advertiser can be received. A delivery intention-related element (for example, a picture control, a word control, a form control, or an icon control) may be used to receive the specific operation that is performed by the user and that is valuable to the business of the advertiser. For example, the delivery intention specified by the advertiser is the form intention. In this case, when the terminal device plays the advertisement, if the user fills in information in a form intention-related element displayed in the advertisement, it indicates that the delivery intention specified by the advertiser is achieved. For another example, the delivery intention specified by the advertiser is the activation intention. In this case, when the terminal device plays the advertisement, if the user taps an activation intention-related element (for example, an icon control of an application) in the advertisement, it indicates that the delivery intention specified by the advertiser is achieved.

In a possible implementation, the first advertisement includes a first advertisement copy, the second advertisement includes a second advertisement copy, the second advertisement copy is generated by embedding first text in the first advertisement copy, and the first text is determined based on the first delivery intention.

The first text may be generated after the embedded delivery intention-related element is expressed as a copy. For example, the first delivery intention is the form intention, and the first interface element is the form intention-related element. In this case, the first text may be determined based on the form intention. To be specific, the first text is form intention-related text, and the first text may be, for example, text (for example, “Fill in information in the form on the left”) generated after the form intention-related element is expressed as a copy.

In this way, the expression of the delivery intention-related element in the advertisement picture can be reflected in the advertisement copy, so that core information such as the delivery intention of the advertisement is conveyed with picture-copy consistency.

In a possible implementation, the first interface element is embedded in a blank area in the first advertisement, and the blank area does not include another interface element in the first advertisement.

The blank area may be, for example, a background area or an instance-free area in the advertisement picture. To be specific, the embedded element does not block original content in the advertisement (for example, another interface element like a word or a picture in the advertisement).

In this way, after the first interface element is embedded, display of other content in the original advertisement may not be affected.

In a possible implementation, before the terminal device displays the second advertisement in the first user interface, the method further includes: The terminal device sends a first message to a server, where the first message is used by the server to generate the second advertisement based on the first advertisement and the first delivery intention; and the terminal device receives a second message sent by the server, where the second message includes information about the second advertisement. That the terminal device displays the second advertisement in the first user interface specifically includes: The terminal device displays the second advertisement in the first user interface based on the information about the second advertisement.

The first message may be, for example, a message 1 shown in FIG. 4A. The second message may be, for example, a message 2 shown in FIG. 4A.

In this way, the terminal device can implement, through the server, an objective of embedding the delivery intention-related element in the original advertisement to generate a new advertisement.

In a possible implementation, the first advertisement further includes a second interface element and a third interface element, and the second interface element is different from the third interface element. The method further includes: The terminal device detects a third user operation in the first user interface; the terminal device obtains a second delivery intention of the first advertisement in response to the third user operation; and the terminal device displays a third advertisement in the first user interface, where the third advertisement does not include the second interface element, the third advertisement is generated after the second interface element is removed from the first advertisement or the third advertisement is generated after the second interface element is replaced with a fourth interface element in the first advertisement, the second interface element is unrelated to the second delivery intention, the third interface element is related to the second delivery intention, and the third interface element is used to receive a fourth user operation.

The first advertisement may be the advertisement before the editing (namely, the original advertisement, for example, an advertisement that is shown in FIG. 10B and that includes a plurality of delivery intentions). The third advertisement may be an advertisement generated after the first advertisement is edited (namely, a new advertisement, for example, an advertisement that is shown in FIG. 10G and that includes only the delivery intention specified by the advertiser). The second interface element may be an element (for example, a picture control, a word control, a form control, or an icon control) unrelated to the second delivery intention. The third interface element may be an element (for example, a picture control, a word control, a form control, or an icon control) related to the second delivery intention. The second delivery intention may be the delivery intention specified by the advertiser. The third user operation may include an operation of setting the delivery intention (for example, a delivery intention like wake-up, next-day retention, payment, activation, registration, a form, or customization) by the user (for example, the advertiser or the advertisement designer entrusted by the advertiser) (for example, an operation of selecting the form delivery intention by the user, where the operation implements, for example, delivery intention setting shown in FIG. 10B), and may further include the operation of setting the system function (for example, the system function like the delivery intention embedding, the delivery intention correction, or the delivery intention extraction) by the user (for example, the operation of selecting the delivery intention extraction system function by the user, where the operation implements, for example, the system function setting shown in FIG. 10B). The fourth user operation may be an operation performed by the user (for example, the user watching the advertisement, for example, the consumer) on the third interface element when the third advertisement is played. In other words, the third interface element may be used to receive a user operation. The fourth interface element may be an element related to the second delivery intention, or may be a delivery intention-unrelated element (namely, an element that does not represent any delivery intention).

In this way, when the advertisement includes both the correct delivery intention (namely, the delivery intention specified by the advertiser) and an incorrect/interfering delivery intention (namely, a delivery intention that is inconsistent with the delivery intention specified by the advertiser), the delivery intention in the advertisement can be updated, and only the delivery intention specified by the advertiser is retained, so that a user behavior guidance function implemented by the advertisement matches the delivery intention specified by the advertiser.

In a possible implementation, the method further includes: The terminal device embeds, based on a user selection operation, the fourth interface element in an area in which the second interface element is located.

In this way, the terminal device can support the user in manually performing an operation to edit the original advertisement to generate the new advertisement. For example, the user may select the fourth interface element from an advertisement material library, and embed the fourth interface element in the area in which the second interface element is located, to replace the second interface element with the fourth interface element (that is, block the second interface element with the fourth interface element), so that the new advertisement no longer includes the second interface element.

In a possible implementation, that the terminal device embeds, based on the user selection operation, the fourth interface element in the area in which the second interface element is located specifically includes: The terminal device displays a second advertisement material library in the first user interface, where the second advertisement material library includes one or more interface elements, and the one or more interface elements include the fourth interface element; and the terminal device drags, based on the user selection operation, the fourth interface element from the second advertisement material library to the area in which the second interface element is located.

The second advertisement material library may be a search result generated by searching the first advertisement material library, and may include the element related to the delivery intention specified by the advertiser and the element unrelated to the delivery intention. The user may select the fourth interface element from the second advertisement material library, and drag the fourth interface element to the area in which the second interface element is located, to replace the second interface element with the fourth interface element (that is, block the second interface element with the fourth interface element), so that the new advertisement no longer includes the second interface element.

In this way, the drag operation of the user can quickly replace the second interface element with the fourth interface element, which is convenient and fast, and improves user experience.

In a possible implementation, the first advertisement copy includes second text and third text, the second text is unrelated to the second delivery intention, the third text is related to the second delivery intention, the third advertisement includes a third advertisement copy, and the third advertisement copy is generated after the second text is removed from the first advertisement copy.

The first advertisement copy is an advertisement copy of the first advertisement. The second text may be generated after the second interface element is expressed as a copy. The third text may be generated after the third interface element is expressed as a copy. For example, the second delivery intention is a form intention, the second interface element is a wake-up intention-related element, and the third interface element is a form intention-related element. In this case, the second text may be, for example, text (for example, “Tap the circular icon to access the application” shown in FIG. 10B) generated after the wake-up intention-related element is expressed as a copy, and the third text may be, for example, text (for example, “Fill in information in the rectangular form” shown in FIG. 10B) generated after the form intention-related element is expressed as a copy.

In this way, the expression of the element that is in the advertisement picture and that is related to the delivery intention specified by the advertiser can be reflected in the advertisement copy, and an expression of an element that is in the advertisement copy and that is inconsistent with the delivery intention specified by the advertiser can be removed, so that the core information such as the delivery intention of the advertisement is conveyed with the picture-copy consistency, and a misleading delivery intention is suppressed.

In a possible implementation, display manners of the second text and the third text are different.

The display manners being different may be implemented by making different marks on the text. A marking manner may include but is not limited to a word color, a word background color, a detection box, and text location coordinates.

In this way, text representing different delivery intentions can be displayed differently, to facilitate viewing by the user.

In a possible implementation, display manners of the second interface element and the third interface element are different.

The display manners being different may be implemented by making different marks on the interface elements. A marking manner may include but is not limited to a heat map, a detection box, a contour line, and a coordinate value.

In this way, elements representing different delivery intentions can be displayed differently, to facilitate viewing by the user.

In a possible implementation, the first advertisement includes a fifth interface element. The method further includes: the terminal device a fifth user operation in the first user interface; the terminal device obtains a third delivery intention of the first advertisement in response to the fifth user operation; and the terminal device displays a fourth advertisement in the first user interface, where the fourth advertisement is generated after the fifth interface element is replaced with a sixth interface element in the first advertisement, the sixth interface element is determined based on the third delivery intention, and the sixth interface element is used to receive a sixth user operation.

The first advertisement may be the advertisement before the editing (namely, the original advertisement, for example, an advertisement shown in FIG. 7B). The fourth advertisement may be an advertisement generated after the first advertisement is edited (namely, a new advertisement, for example, an advertisement shown in FIG. 7C). The fifth interface element may be an element (for example, a picture control, a word control, a form control, or an icon control) unrelated to the third delivery intention. The sixth interface element may be an element (for example, a picture control, a word control, a form control, or an icon control) related to the third delivery intention. The third delivery intention may be the delivery intention specified by the advertiser. The fifth user operation may include an operation of setting the delivery intention (for example, a delivery intention like wake-up, next-day retention, payment, activation, registration, a form, or customization) by the user (for example, the advertiser or the advertisement designer entrusted by the advertiser) (for example, an operation of selecting the form delivery intention by the user, where the operation implements, for example, delivery intention setting shown in FIG. 7B), and may further include the operation of setting the system function (for example, the system function like the delivery intention embedding, the delivery intention correction, or the delivery intention extraction) by the user (for example, the operation of selecting the delivery intention correction system function by the user, where the operation implements, for example, the system function setting shown in FIG. 7B). The sixth user operation may be an operation performed by the user (for example, the user watching the advertisement, for example, the consumer) on the sixth interface element when the fourth advertisement is played. In other words, the sixth interface element may be used to receive a user operation.

In a possible implementation, the sixth interface element is obtained from the first advertisement material library.

The first advertisement material library may be, for example, an advertisement material library that is shown in FIG. 7B and that is displayed in an advertisement material display and interaction area. The sixth interface element may be obtained from the first advertisement material library.

In this way, when an element related to a delivery intention needs to be obtained, one or more elements related to the delivery intention can be searched for from the first advertisement material library. When a plurality of elements are found, an element may be selected according to the preset rule and embedded in an area in which an element that is in the original advertisement and that is unrelated to the delivery intention is located, to replace the element that is in the original advertisement and that is unrelated to the delivery intention, so as to generate the new advertisement.

In a possible implementation, the first advertisement copy includes fourth text, the fourth text is unrelated to the third delivery intention, the fourth advertisement includes a fourth advertisement copy, the fourth advertisement copy is generated after the fourth text is removed from and fifth text is embedded in the first advertisement copy, and the fifth text is determined based on the third delivery intention.

The first advertisement copy is an advertisement copy of the first advertisement. The fourth text may be generated after the fifth interface element is expressed as a copy. The fifth text may be generated after the sixth interface element is expressed as a copy (to be specific, the fifth text is determined based on the third delivery intention). For example, the third delivery intention is a form intention, the fifth interface element is a wake-up intention-related element, and the sixth interface element is a form intention-related element. In this case, the fourth text may be, for example, text (for example, “Tap the circular icon to access the application” shown in FIG. 7B) generated after the wake-up intention-related element is expressed as a copy, and the fifth text may be, for example, text (for example, “Fill in information in the rectangular form” shown in FIG. 7C) generated after the form intention-related element is expressed as a copy.

In this way, the expression of the element that is in the advertisement picture and that is related to the delivery intention specified by the advertiser can be reflected in the advertisement copy, and an expression of an element that is in the advertisement copy and that is inconsistent with the delivery intention specified by the advertiser can be removed, so that the core information such as the delivery intention of the advertisement is conveyed with the picture-copy consistency, and a misleading delivery intention is suppressed.

In this application, three system functions: the delivery intention embedding, the delivery intention correction, and the delivery intention extraction, may be all included, or only one or two of the three system functions may be included.

According to a second aspect, an embodiment of this application provides an advertisement generation method, applied to a terminal device. The method includes: the terminal device displays a first advertisement in a first user interface, where the first advertisement includes a second interface element and a third interface element, and the second interface element is different from the third interface element; the terminal device detects a third user operation in the first user interface; the terminal device obtains a second delivery intention of the first advertisement in response to the third user operation; and the terminal device displays a third advertisement in the first user interface, where the third advertisement does not include the second interface element, the third advertisement is generated after the second interface element is removed from the first advertisement or the third advertisement is generated after the second interface element is replaced with a fourth interface element in the first advertisement, the second interface element is unrelated to the second delivery intention, the third interface element is related to the second delivery intention, and the third interface element is used to receive a fourth user operation.

According to a third aspect, an embodiment of this application provides an advertisement generation method, applied to a terminal device. The method includes: the terminal device displays a first advertisement in a first user interface, where the first advertisement includes a fifth interface element; the terminal device detects a fifth user operation in the first user interface; the terminal device obtains a third delivery intention of the first advertisement in response to the fifth user operation; and the terminal device displays a fourth advertisement in the first user interface, where the fourth advertisement is generated after the fifth interface element is replaced with a sixth interface element in the first advertisement, the sixth interface element is determined based on the third delivery intention, and the sixth interface element is used to receive a sixth user operation.

According to a fourth aspect, an embodiment of this application provides an electronic device. The electronic device includes one or more processors and one or more memories. The one or more memories are coupled to the one or more processors. The one or more memories are configured to store computer program code. The computer program code includes computer instructions. When the one or more processors execute the computer instructions, the electronic device is enabled to perform the method according to any possible implementation of the first aspect, or the second aspect, or the third aspect.

According to a fifth aspect, an embodiment of this application provides a computer storage medium. The computer storage medium stores a computer program. The computer program includes program instructions. When the program instructions are run on an electronic device, the electronic device is enabled to perform the method according to any possible implementation of the first aspect, the second aspect, or the third aspect.

According to a sixth aspect, an embodiment of this application provides a computer program product. When the computer program product runs on a computer, the computer is enabled to perform the method according to any possible implementation of the first aspect, the second aspect, or the third aspect.

### BRIEF DESCRIPTION OF THE DRAWINGS

FIG. 1A and FIG. 1B are diagrams of a scenario of delivery intention embedding according to an embodiment of this application;

FIG. 2A and FIG. 2B are diagrams of a scenario of delivery intention correction according to an embodiment of this application;

FIG. 3A and FIG. 3B are diagrams of a scenario of delivery intention extraction according to an embodiment of this application;

FIG. 3C is a diagram of a communication system according to an embodiment of this application;

FIG. 4A is a schematic flowchart of an advertisement generation method in a delivery intention embedding scenario according to an embodiment of this application;

FIG. 4B to FIG. 4I are diagrams of a series of user interfaces in an advertisement generation method in a delivery intention embedding scenario according to an embodiment of this application;

FIG. 5A to FIG. 5D are diagrams of specific application scenarios of embedding delivery intentions in an original advertisement picture-copy to generate new advertisement picture-copies according to an embodiment of this application;

FIG. 6A to FIG. 6F are a series of diagrams in a specific implementation process of embedding a delivery intention in an advertisement picture-copy according to an embodiment of this application;

FIG. 7A is a schematic flowchart of an advertisement generation method in a delivery intention correction scenario according to an embodiment of this application;

FIG. 7B and FIG. 7C are diagrams of a series of user interfaces in an advertisement generation method in a delivery intention correction scenario according to an embodiment of this application;

FIG. 8A and FIG. 8B are diagrams of a specific application scenario of performing delivery intention correction on an original advertisement picture-copy to generate a new advertisement picture-copy according to an embodiment of this application;

FIG. 9A to FIG. 9E are a series of diagrams in a specific implementation process of delivery intention correction according to an embodiment of this application;

FIG. 10A-1 and FIG. 10A-2 are a schematic flowchart of an advertisement generation method in a delivery intention extraction scenario according to an embodiment of this application;

FIG. 10B to FIG. 10G are a series of diagrams of an advertisement generation method in a delivery intention extraction scenario according to an embodiment of this application;

FIG. 11A and FIG. 11B are diagrams of a specific application scenario of performing delivery intention extraction on an original advertisement picture-copy to generate a new advertisement picture-copy according to an embodiment of this application;

FIG. 12 is a diagram of a possible manner of collaboration between an internal module of a terminal device 100 and an internal module of a server 200 in a process of performing an advertisement generation method according to an embodiment of this application;

FIG. 13 is a diagram of a structure of a server 200 according to an embodiment of this application; and

FIG. 14 is a diagram of a structure of a terminal device 100 according to an embodiment of this application.

### DETAILED DESCRIPTION OF ILLUSTRATIVE EMBODIMENTS

The following clearly and fully describes technical solutions in embodiments of this application with reference to accompanying drawings in embodiments of this application. In the descriptions of embodiments of this application, “/” indicates “or” unless otherwise specified. For example, A/B may indicate A or B. The term “and/or” in this specification describes merely an association relationship between associated objects, and indicates that three relationships may exist. For example, A and/or B may indicate the following three cases: Only A exists, both A and B exist, and only B exists. In addition, in the descriptions of embodiments of this application, “a plurality of” means two or more.

It should be understood that the terms “first”, “second”, and the like in this specification, the claims, and the accompanying drawings of this application are intended to distinguish between different objects, but do not indicate a particular order. In addition, the terms “including” and “having” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

An “embodiment” mentioned in this application means that a particular feature, structure, or feature described with reference to the embodiment may be included in at least one embodiment of this application. The phrase shown at various locations in this specification may not necessarily mean a same embodiment, and is not an independent or optional embodiment exclusive from another embodiment. It is explicitly and implicitly understood by persons skilled in the art that embodiments described in this application may be combined with another embodiment.

The term “user interface (UI)” in the following embodiments of this application is a medium interface for interaction and information exchange between an application or an operating system and a user, and the user interface implements conversion between an internal form of information and a form that can be accepted by the user. The user interface is source code written in a specific computer language like Java or an extensible markup language (XML). The interface source code is parsed and rendered on an electronic device, and is finally presented as content that can be identified by the user. A commonly-used representation form of the user interface is a graphical user interface (GUI), and is a user interface that is displayed in a graphical manner and that is related to a computer operation. The user interface may be a visual interface element like text, an icon, a button, a menu, a tab, a text box, a dialog box, a status bar, a navigation bar, or a widget that is displayed on a display of the electronic device.

An advertisement generation method provided in embodiments of this application may be applied to a plurality of advertisement delivery scenarios.

For ease of understanding, several typical advertisement delivery scenarios and advertisement delivery intentions (which may also be referred to as advertisement conversion intentions) are first described.

### Typical Advertisement Delivery Scenarios

### 1. Splash Screen

An advertisement is displayed when an application is started and loaded, and after being displayed, the advertisement is automatically stopped and a main interface of the application is accessed, which is applicable to display in an application that is frequently used by a large quantity of active users.

### 2. Interstitial

An advertisement is displayed when an application is started, paused, or exited, and a display moment may cleverly avoid normal user experience of the application. Attention of a user is quickly attracted, a size is large, and exposure effect is good.

### 3. Native

Advertisement content is embedded in a design of an application as a part of an information stream or service content, which causes little interference to a user and is common in an information stream scenario.

### 4. Banner

Advertisement content is displayed in an application in a manner of a notification bar or a rectangle, which is applicable to display on a page on which a user stays for a long time or that is frequently accessed by the user.

### 5. Rewarded Video

A user obtains a corresponding reward in an application by watching a complete video advertisement, which has good user experience and a high profit and is generally applicable to a game application.

The advertisement generation method provided in embodiments of this application is not limited to being applied to the foregoing several typical advertisement delivery scenarios, and may be further applied to another advertisement delivery scenario supported by an advertisement delivery medium. This is not limited in embodiments of this application.

### Typical Advertisement Delivery Intentions

### 1. Wake-Up

Before an advertisement is displayed, a user has downloaded and installed an application. When the advertisement is displayed, the user performs an operation on advertisement content (for example, performs a tap operation on a word or an icon in the advertisement content) to start the application.

### 2. Next-Day Retention

A user downloads and installs an application based on a recommendation advertisement for the application. The user starts the application again on a next day after the application is downloaded and installed.

### 3. Payment

A user pays for related content recommended in an advertisement. For example, a commodity is recommended and a commodity purchase link is provided in the advertisement, and the user taps the link to access a commodity details page and places an order to purchase the product.

### 4. Activation

Before an advertisement is displayed, a user does not download and install an application. When the advertisement is displayed, the user performs an operation on advertisement content (for example, performs a tap operation on a word or an icon in the advertisement content) to download and install the application, and starts the application after the installation is completed.

### 5. Registration

A user registers an account based on related content in an advertisement.

### 6. Form

A user fills in information based on related content in an advertisement, so that an advertiser can collect user information in a manner of the form.

An advertisement delivery intention is not limited to the foregoing several typical advertisement delivery intentions, and may further include more valuable user behaviors customized by the advertiser. This is not limited in embodiments of this application.

In this application, a delivery intention may mean that, when a terminal device plays an advertisement, a specific operation that is performed by a user and that is valuable to a business of an advertiser can be received. A delivery intention-related element (for example, a picture control, a word control, a form control, or an icon control) may be used to receive the specific operation that is performed by the user and that is valuable to the business of the advertiser.

In this application, the advertisement (which may also be referred to as an advertisement picture-copy) may include both an advertisement picture and an advertisement copy, or the advertisement may include only the advertisement picture or the advertisement copy.

Conversion guidance missing is an important factor that causes a low conversion rate of advertisement delivery. Before the advertisement delivery, the advertiser generally specifies a specific user operation (for example, activation, wake-up, or a form) that is valuable to the business of the advertiser. An advertisement delivery platform charges, based on achievement of a conversion goal specified by the advertiser, the advertisement delivered by the advertiser. However, many advertisers generally ignore conversion guidance in creative designs of advertisements, and the user watches the advertisement or taps related content in the advertisement, but does not perform the specific operation that is valuable to the business of the advertiser. As a result, the conversion rate of the advertisement delivery is low.

Currently, an automatic advertisement copy generation technology can resolve, to some extent, a problem that the advertisement picture and the advertisement copy are unrelated to each other, and can support generation of advertisement copies for different scenarios (for example, generation of differentiated advertisement copies for different marketing scenarios such as a top-selling item, a promotion, and a new product). However, the advertisement copies generated using the automatic advertisement copy generation technology generally have phenomena such as “relying on an original copy or a keyword in an original copy”, “introduction of incorrect information”, and “severe templatization”. As a result, the delivery intention of the advertiser cannot be embedded in the advertisement. In addition, for modification of the advertisement copy, the automatic advertisement copy generation technology is not applicable to display advertisements such as a splash advertisement, an interstitial advertisement, and a banner advertisement, and an application scenario is limited.

For example, currently, there is a typical solution for generating the advertisement copy. First, a product knowledge base is constructed for a commodity for which an advertisement is to be delivered, content generated by the user is periodically obtained from an internet, and the content is converted into a graph. Then, key information representing a user intention is obtained from the graph. Finally, a content point of the to-be-delivered advertisement is determined based on the user intention and the product knowledge base, and the content point is input into a preset advertisement language model, to generate the advertisement copy.

It can be learned that the application scenario of the foregoing advertisement effect improvement solution for the advertisement copy is limited, and the solution is not applicable to delivery scenarios in which no advertisement copy is presented, for example, a splash screen, a banner, and an interstitial. In addition, the solution generates the advertisement copy with an objective of highlighting an advertisement selling point, and cannot embed information in a delivery intention dimension in the advertisement. Moreover, the solution supports only conveyance of a main attribute of advertisement content, and cannot identify and correct an element (for example, a picture element) that is in the advertisement and that misleads the delivery intention.

In existing solutions, there are still some solutions similar to the foregoing solution. In summary, disadvantages commonly existing in these solutions include the following three points.
1. Application scenarios are limited, and these solutions are not applicable to the delivery scenarios in which no advertisement copy is presented, for example, the splash screen, the banner, and the interstitial.
2. Only key information in the advertisement content can be extracted and conveyed, and the delivery intention of the advertiser cannot be integrated into the advertisement. For example, the element related to the delivery intention of the advertiser cannot be embedded in the advertisement picture, and a correlation of delivery intentions in the advertisement picture and the advertisement copy cannot be reflected in a generated advertisement copy.
3. A delivery intention misleading element existing in the advertisement picture cannot be corrected, and a target delivery intention cannot be extracted.

Based on the foregoing problems, embodiments of this application provide an advertisement generation method. When a delivery intention specified by an advertiser is missing in an advertisement picture-copy, a delivery intention-related element (or referred to as a delivery intention-related material) may be embedded in an advertisement picture, and an expression of the embedded delivery intention-related element is reflected in an advertisement copy. In this way, the delivery intention-related element in the advertisement picture can be intuitively reflected in an expression of the advertisement copy, so that core information such as the delivery intention of an advertisement is conveyed with picture-copy consistency. This method is applicable to diversified advertisement delivery scenarios such as a picture advertisement, a copy advertisement, and a picture-copy advertisement. In addition, when an incorrect/interfering delivery intention (namely, a delivery intention that is inconsistent with the delivery intention specified by the advertiser) exists in the advertisement picture-copy, an element related to a correct delivery intention (namely, the delivery intention specified by the advertiser) may be embedded in the advertisement picture, an element related to the incorrect/interfering delivery intention may be covered or removed, a related expression of the incorrect/interfering delivery intention in the advertisement copy may be further removed, and the element that has been embedded in the advertisement picture and that is related to the correct delivery intention is expressed as a copy and then embedded in the advertisement copy. In this way, a misleading delivery intention in the advertisement picture-copy can be corrected, and the delivery intention specified by the advertiser can be embedded in the advertisement picture-copy, so that the advertisement has an intuitive user behavior guidance function. This helps improve advertisement conversion effect.

Embodiments of this application provide an advertisement generation method, mainly including the following three solutions.

### Solution 1: Delivery Intention Embedding

The “delivery intention embedding” may mean embedding, in an advertisement picture-copy, an element (for example, a picture, a control/button, an icon, an edit box, or an artistic word) and/or text related to a delivery intention specified by an advertiser.

First, a delivery intention-related element is located in an advertisement picture, and a delivery intention-related text segment is located in an advertisement copy. Then, advertisement content (for example, a partial picture or text segment) that is strongly related to the delivery intention specified by the advertiser is screened. When the element related to the delivery intention specified by the advertiser is missing in the advertisement picture, the delivery intention-related element (for example, an application jump-related button/copy corresponding to a wake-up intention, or a recharge preference-related icon/copy corresponding to a payment intention) may be searched for in an advertisement material library of the advertiser. Further, an advertisement-unrelated/weakly related area (for example, a background area or an instance-free area) in the advertisement picture may be located, and a found delivery intention-related element is embedded in the area, to generate a new advertisement picture. When the text related to the delivery intention specified by the advertiser is missing in the advertisement copy, the delivery intention-related element that has been embedded in the advertisement picture may be expressed as a copy (for example, after being expressed as a copy, a registration intention-related element may be “Tap the icon below for registration”, or after being expressed as a copy, a form intention may be “Fill in information in the information box on the right”) and then embedded in the advertisement copy and fine-tuned, to generate a semantically continuous new advertisement copy.

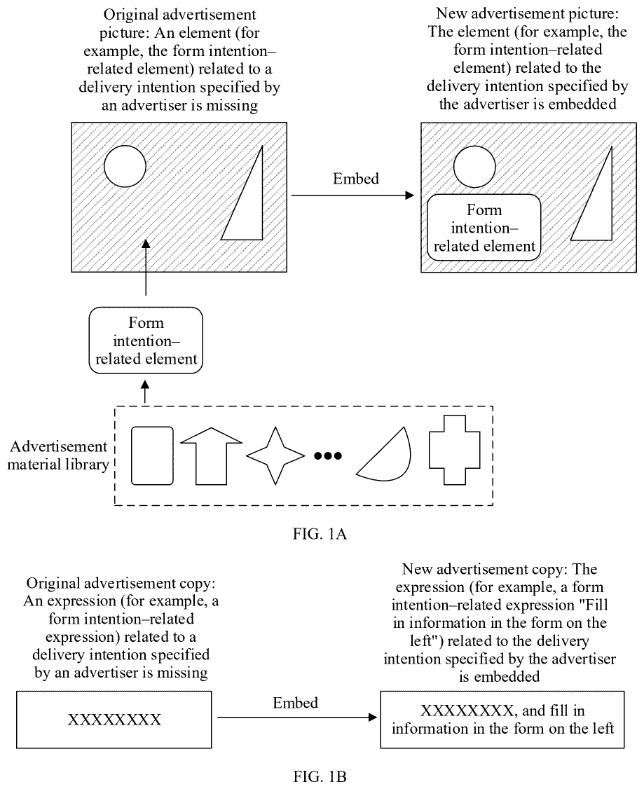

For example, it is assumed that the delivery intention specified by the advertiser is a form intention. With reference to FIG. 1A, a form intention-related element is missing in an original advertisement picture if intentions represented by triangular and circular elements in the original advertisement picture are not form intentions (in an example, a triangle and a circle are used as examples for description, and in an actual scenario, may be any advertisement elements). In this case, the form intention-related element, for example, an element represented by a rectangle (in an actual scenario, the rectangle may be any form-related advertisement element) may be searched for in the advertisement material library, and embedded in an appropriate location (namely, a location that does not block main information in the advertisement picture) in the advertisement picture, to generate a new advertisement picture that includes the form intention-related element. With reference to FIG. 1B, if form intention-related text (or referred to as a form intention-related expression) is missing in an original advertisement copy “XXXXXXXX” (for example, “Tap for purchase”), the form intention-related element that has been embedded in the original advertisement picture may be expressed as a copy (for example, “Fill in information in the form on the left”), and then embedded in the original advertisement copy, to generate a new advertisement copy that includes the form intention-related text (for example, “XXXXXXXX, and fill in information in the form on the left”).

### Solution 2: Delivery Intention Correction

The “delivery intention correction” may mean replacing, with a related element and/or related text that are/is consistent with a delivery intention specified by an advertiser, a related element and/or related text that are/is inconsistent with the delivery intention specified by the advertiser, or directly removing the related element and/or the related text that are/is inconsistent with the delivery intention specified by the advertiser.

First, a main delivery intention presented in an advertisement picture is identified, and an element (for example, a picture element) that is strongly related to the main delivery intention in the advertisement picture is located. In addition, a main delivery intention expressed in an advertisement copy is identified, and a text segment that is strongly related to the main delivery intention in the advertisement copy is located. Then, consistency between the delivery intention specified by the advertiser and each of the delivery intention represented in the advertisement picture and the delivery intention represented in the advertisement copy is separately calculated. When the main delivery intention presented in the advertisement picture is inconsistent with the delivery intention specified by the advertiser (namely, a correct delivery intention) (for example, a consistency coefficient is less than a preset value t), the element related to the delivery intention specified by the advertiser may be searched for in an advertisement material library of the advertiser, and embedded in the advertisement picture, and an element related to an incorrect/interfering delivery intention in the advertisement picture (namely, a delivery intention-related element that is inconsistent with the correct delivery intention) may be covered or removed, to generate a new advertisement picture. When the main delivery intention expressed in the advertisement copy is inconsistent with the delivery intention specified by the advertiser, a text segment related to the incorrect/interfering delivery intention in the advertisement copy may be removed, and the element that has been embedded in the advertisement picture and that is related to the delivery intention specified by the advertiser is expressed as a copy and then embedded in remaining text in the advertisement copy and fine-tuned, to generate a semantically continuous new advertisement copy.

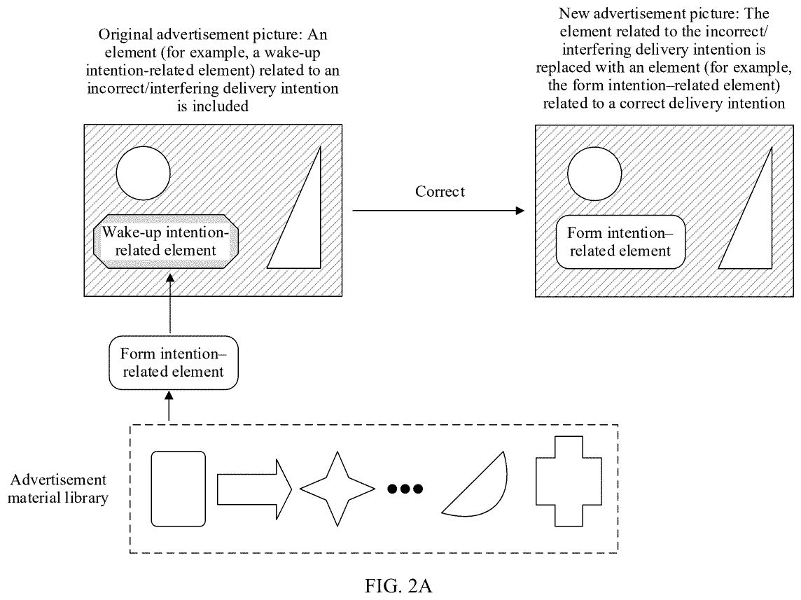

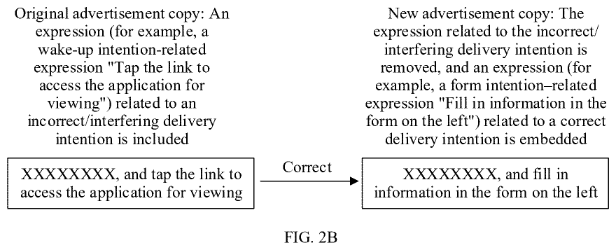

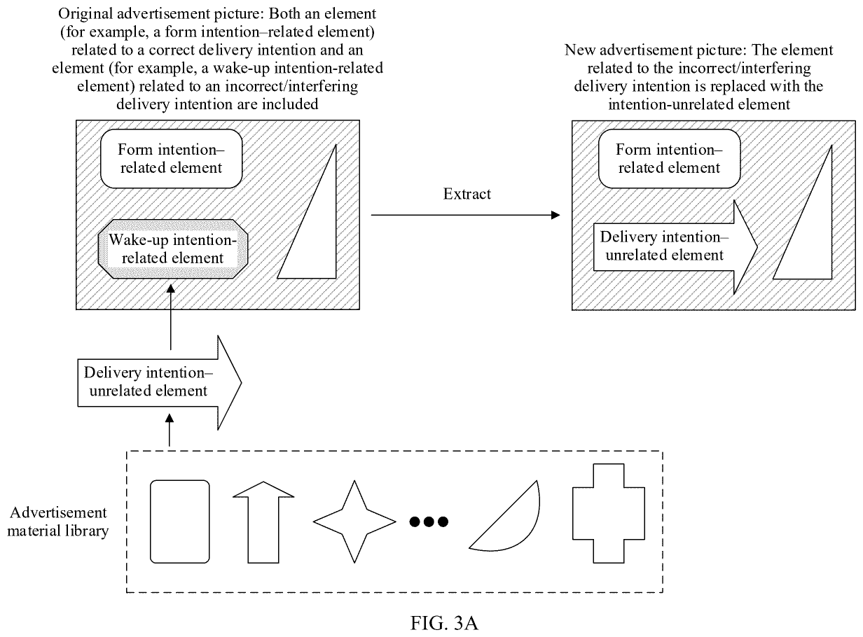

For example, it is assumed that the delivery intention specified by the advertiser is a form intention. With reference to FIG. 2A, if intentions represented by a triangular element, a circular element, and an octagonal element in an original advertisement picture are not form intentions (in an example, a triangle, a circle, and an octagon are used as examples for description, and in an actual scenario, may be any advertisement elements), a form intention-related element is missing in the original advertisement picture, and the element related to the incorrect/interfering delivery intention (for example, the octagonal element representing a wake-up intention) exists. In this case, the form intention-related element, for example, an element represented by a rectangle (in an actual scenario, the rectangle may be any form-related advertisement element) may be searched for in the advertisement material library, and embedded in a location of the element related to the incorrect/interfering delivery intention in the original advertisement picture, to cover the element related to the incorrect/interfering delivery intention (or embedded in an appropriate location in the original advertisement picture, and the element related to the incorrect/interfering delivery intention may be removed), so as to generate a new advertisement picture that includes the form intention-related element. With reference to FIG. 2B, if form intention-related text is missing in an original advertisement copy “XXXXXXXX, and tap the link to access the application for viewing” (for example, “For the product details, tap the link to access the application for viewing”), and a text segment related to the incorrect/interfering delivery intention (for example, a wake-up intention-related expression “Tap the link to access the application for viewing”) exists, the text segment related to the incorrect/interfering delivery intention in the original advertisement copy may be removed, and the form intention-related element that has been embedded in the original advertisement picture may be expressed as a copy (for example, “Fill in information in the form on the left”) and then embedded in the original advertisement copy, to generate a new advertisement copy that includes the form intention-related text (for example, “XXXXXXXX, and fill in information in the form on the left”).

### Solution 3: Delivery Intention Extraction

The “delivery intention extraction” may mean that, when a plurality of delivery intentions exist in an advertisement picture-copy, a related element and/or related text that are/is inconsistent with a delivery intention specified by an advertiser may be visually presented to a user, and the user is supported to perform an operation like manually correcting a delivery intention, to update the delivery intention in the advertisement picture-copy.

First, all delivery intentions represented in an advertisement picture and an advertisement copy are identified, and a delivery intention-related element (for example, a picture element) and a delivery intention-related text segment that correspond to each delivery intention are located. Then, strength degrees d of the delivery intentions represented in the advertisement picture and the advertisement copy are separately calculated, and a strongly related delivery intention (which may also be referred to as a strongly limited delivery intention or a main delivery intention) is screened based on d and a threshold k preset by a user. When d>k, it may be considered that the represented delivery intention is a strongly related delivery intention. When an element related to the strongly related delivery intention in the advertisement picture includes both an element related to a correct delivery intention (which may also be referred to as a target delivery intention, namely, the delivery intention specified by the advertiser) and an element related to an incorrect/interfering delivery intention, the element related to the correct delivery intention and/or a delivery intention-unrelated element (namely, a delivery intention-unrelated material) may be searched for in an advertisement material library of the advertiser, and presented in a candidate material area in an interactive interface of a terminal device as candidate elements/a candidate element. Further, an advertisement-unrelated/weakly related area (for example, a background area or an instance-free area) and an area related to the incorrect/interfering delivery intention in the advertisement picture may be located and marked (for example, marked using a heat map or a detection box), and displayed in the interactive interface. The terminal device may support the user in dragging the candidate element to the advertisement picture as required, for example, dragging the candidate element to the area related to the incorrect/interfering delivery intention to cover the element related to the incorrect/interfering delivery intention, or directly removing the element related to the incorrect/interfering delivery intention, to generate a new advertisement picture. When a text segment related to the strongly related delivery intention in the advertisement copy includes both a text segment related to the correct delivery intention and a text segment related to the incorrect/interfering delivery intention, the text segment related to the incorrect/interfering delivery intention may be marked (for example, marked using a colored font, a background color, or a detection box), and displayed in the interactive interface. The terminal device may support the user in selecting and removing, as required, the text segment related to the incorrect/interfering delivery intention. Further, the terminal device may fine-tune a remaining advertisement copy, to generate a semantically continuous new advertisement copy.

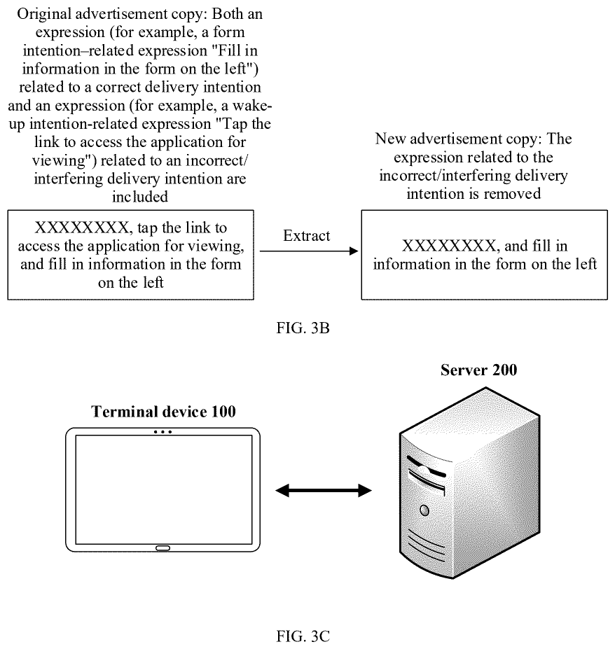

For example, it is assumed that the delivery intention specified by the advertiser is a form intention. With reference to FIG. 3A, if an intention represented by a rectangular element in an original advertisement picture is the form intention, and an octagonal element and a triangular element do not represent form intentions (in an example, a rectangle, an octagon, and a triangle are used as examples for description, and in an actual scenario, may be any advertisement elements), the original advertisement picture includes both a form intention-related element and the element related to the incorrect/interfering delivery intention (for example, the octagonal element representing a wake-up intention). In this case, the delivery intention-unrelated element may be searched for in the advertisement material library, for example, an element represented by an arrow (in an actual scenario, the arrow may be any delivery intention-unrelated element) and embedded in a location of the element related to the incorrect/interfering delivery intention in the original advertisement picture to cover the element related to the incorrect/interfering delivery intention (or the element related to the incorrect/interfering delivery intention may be directly removed), so as to generate a new advertisement picture that includes only the form intention-related element. With reference to FIG. 3B, if an original advertisement copy “XXXXXXXX, tap the link to access the application for viewing, and fill in information in the form on the left” (for example, “For the product details, tap the link to access the application for viewing, and fill in information in the form on the left”) includes both a form intention-related text segment (for example, a form intention-related expression “Fill in information in the form on the left”) and the text segment related to the incorrect/interfering delivery intention (for example, a wake-up intention-related expression “Tap the link to access the application for viewing”), the text segment-related to the incorrect/interfering delivery intention in the original advertisement copy may be removed, to generate a new advertisement copy that includes only the form intention-related text segment (for example, “XXXXXXXX, and fill in information in the form on the left”).

In this application, both Solution 1 and Solution 2 relate to a scenario in which an advertisement picture-copy includes only one delivery intention (or one main delivery intention), Solution 3 relates to a scenario in which an advertisement picture-copy includes a plurality of delivery intentions (or a plurality of main delivery intentions). In addition, in Solution 3, an interaction function is added based on Solution 1 and Solution 2, to support the user in manually performing an editing operation on the advertisement picture-copy in the interactive interface of the terminal device.

The foregoing three solutions are described in detail in the following embodiments. Details are not described herein.

The following describes a communication system provided in embodiments of this application.

FIG. 3C illustrates a communication system according to an embodiment of this application.

As shown in FIG. 3C, the communication system may include a terminal device 100 and a server 200.

The terminal device 100 may be an electronic device having a display, and may be of various types. A specific type of the terminal device 100 is not limited in embodiments of this application. For example, the terminal device 100 may be a mobile phone, a tablet computer, a desktop computer, a laptop computer, a handheld computer, or a notebook computer.

In this embodiment of this application, the terminal device 100 may be configured to display and edit an advertisement picture, and advertisement copy, and the like; may be further configured to set a function/parameter (for example, set embedding, correction, or extraction of an advertisement delivery intention, or set a target delivery intention of an advertiser); may be further configured to perform data communication with another device (for example, the server 200); and the like.

In some examples, the terminal device 100 may further support installation of a plurality of applications, for example, a camera application, an image management application, an image processing application, a word processing application, a phone application, an email application, an instant messaging application, a network communication application, a media playing application, a geographical location positioning application, and a time management application.

In this embodiment of this application, the terminal device 100 may implement the advertisement generation method provided in this application through an advertisement application installed on the terminal device 100, or may implement the advertisement generation method provided in this application through an advertisement delivery platform (or referred to as a creative tool/platform, for example, an advertisement delivery website). This is not limited in embodiments of this application.

The server 200 may be a conventional server, or may be a cloud server. This is not limited in embodiments of this application. For example, the server 200 may be a Windows® server or another server that can provide simultaneous access of a plurality of devices, or may be a server cluster including a plurality of regions, a plurality of equipment rooms, and a plurality of servers. The server 200 may generally support a message storage and distribution program, a large-scale data storage program, a large-scale data processing program, a data redundancy backup program, and the like.

In this embodiment of this application, the server 200 may be configured to perform feature extraction on the advertisement picture, the advertisement copy, and the like; may be further configured to identify a delivery intention of an advertisement picture-copy; may be further configured to synthesize the advertisement picture; may be further configured to synthesize the advertisement copy; may be further configured to generate an advertisement picture-copy mark; may be further configured to perform data communication with another device (for example, the terminal device 100); and the like.

It should be understood that FIG. 3C is merely a diagram of an architecture of the communication system, and should not constitute a limitation on this application. A quantity of terminal devices 100 and a quantity of servers 200 that are included in the communication system are not limited in embodiments of this application.

### Embodiment 1: Delivery Intention Embedding

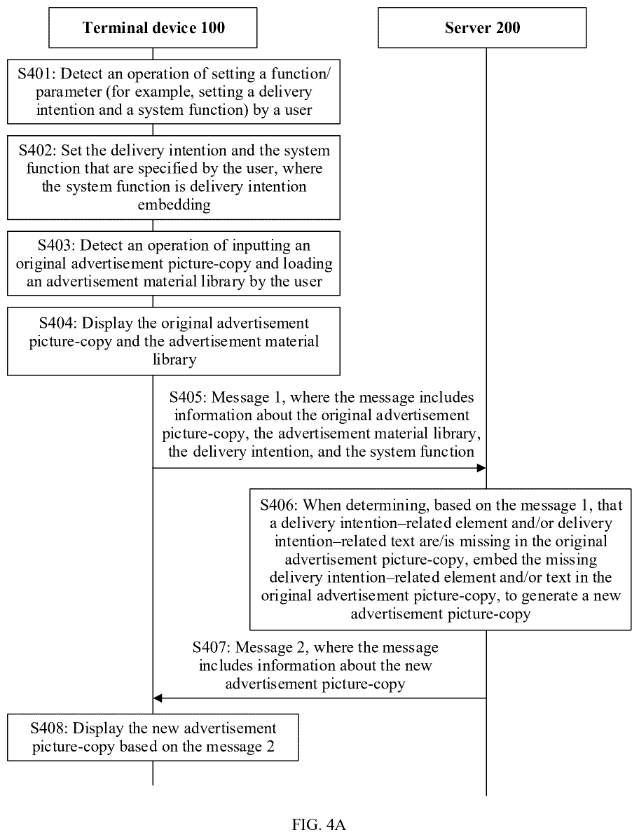

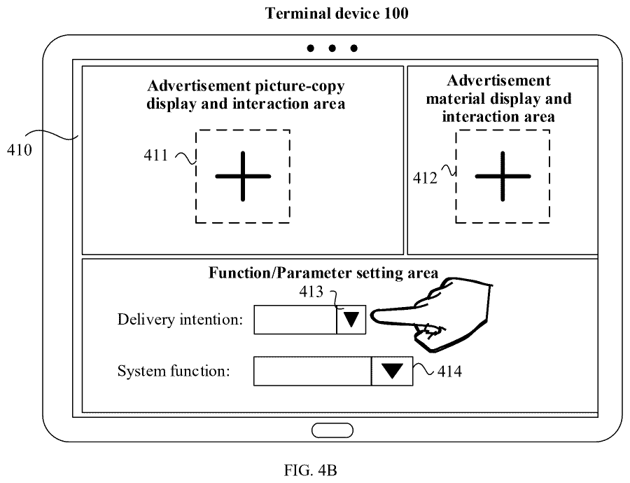

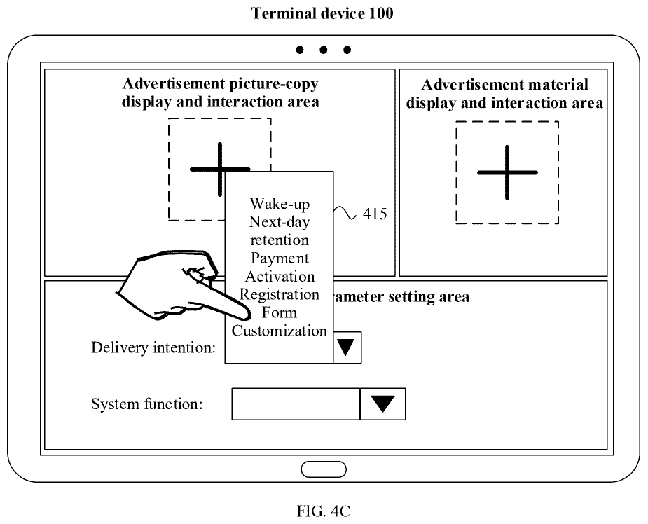

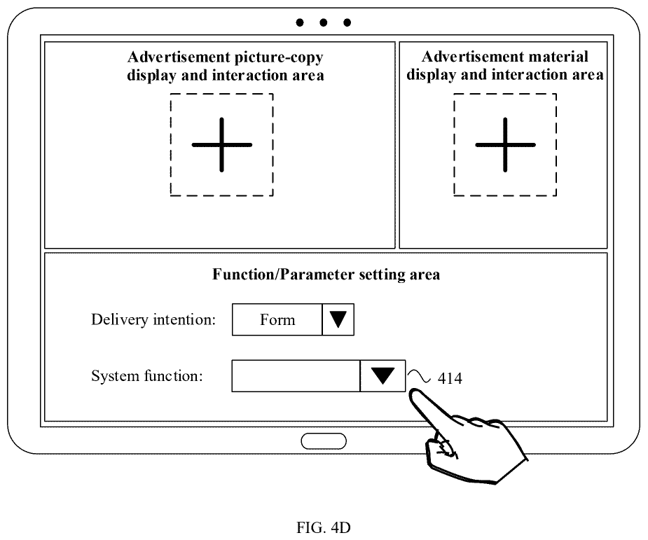

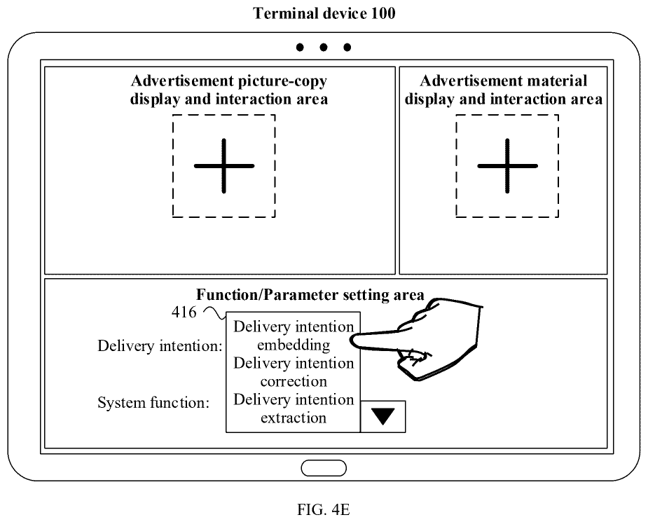

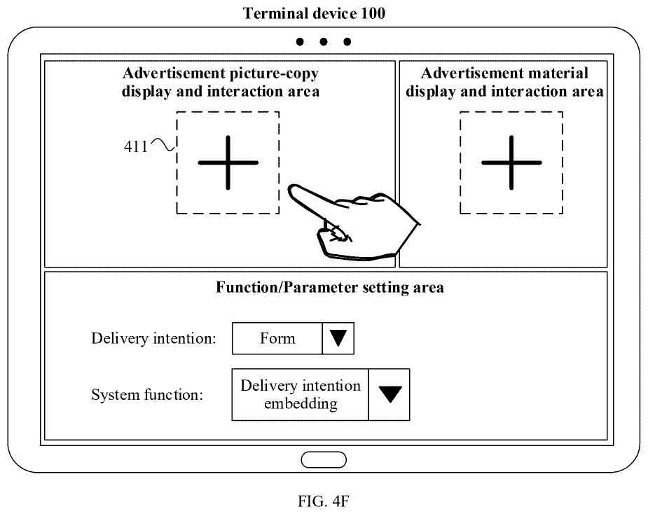

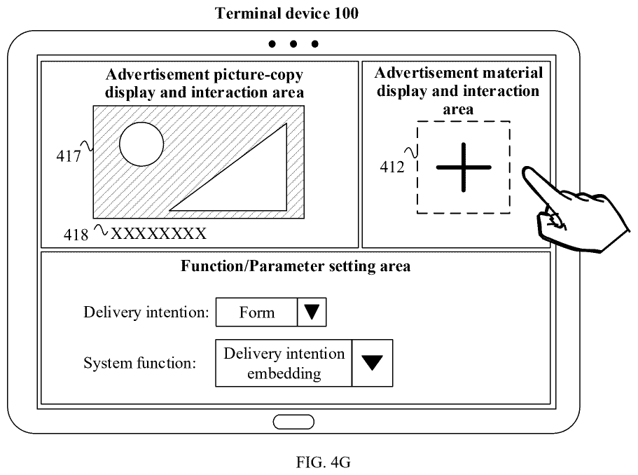

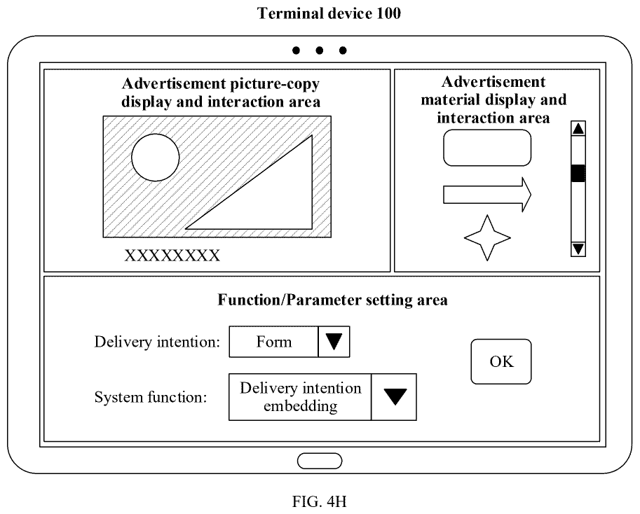

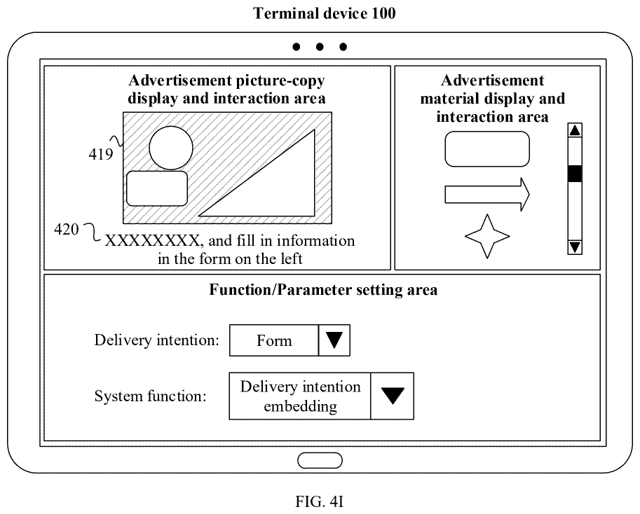

FIG. 4A illustrates a specific procedure of an advertisement generation method in a delivery intention embedding scenario according to an embodiment of this application.

As shown in FIG. 4A, the method may be applied to a communication system including the terminal device 100 and the server 200.

In this embodiment of this application, the terminal device 100 may provide an interactive interface, used to implement a function like displaying or editing an advertisement picture-copy. The interactive interface may be a user interface provided by an advertisement application installed on the terminal device 100, or may be a user interface provided by an advertisement delivery platform. This is not limited in embodiments of this application. The interactive interface may be, for example, a user interface 410 illustrated in FIG. 4B.

With reference to FIG. 4B, the user interface 410 may include a plurality of areas, for example, an advertisement picture-copy display and interaction area, an advertisement material display and interaction area, and a function/parameter setting area. The advertisement picture-copy display and interaction area may be used to display the advertisement picture-copy and receive an operation (for example, an operation of inputting the advertisement picture-copy or editing the advertisement picture-copy) performed by a user on the advertisement picture-copy. The advertisement material display and interaction area may be used to display an advertisement material and receive an operation (for example, an operation of loading an advertisement material library or selecting the advertisement material in the advertisement material library) performed by the user on the advertisement material. The function/parameter setting area may be used to display a configurable delivery intention (for example, a delivery intention like wake-up, next-day retention, payment, activation, registration, a form, or customization) and system function (for example, a system function like delivery intention embedding, delivery intention correction, or delivery intention extraction), and receive setting operations performed by the user on the delivery intention and the system function.

With reference to FIG. 4A to FIG. 4I, the following describes in detail specific steps of the delivery intention embedding.

S401 and S402: The terminal device 100 detects an operation of setting a function/parameter (for example, setting a delivery intention and a system function) by the user, and in response to the operation, the terminal device 100 sets the delivery intention and the system function that are specified by the user, where the system function is the delivery intention embedding.

It is easy to understand that the user may be an advertiser or an advertisement designer entrusted by the advertiser.

With reference to FIG. 4B, the terminal device 100 may support the user in setting the delivery intention and setting the system function in the function/parameter setting area. A time sequence of setting the delivery intention and setting the system function by the user is not limited in embodiments of this application.

For example, the user first sets the delivery intention. The terminal device 100 may detect an operation (for example, a tap operation) performed by the user on an option 413 illustrated in FIG. 4B, and in response to the operation, the terminal device 100 may display a window 415 illustrated in FIG. 4C.

With reference to FIG. 4C, the window 415 may include one or more delivery intention options (for example, delivery intention options such as the wake-up, the next-day retention, the payment, the activation, the registration, the form, and the customization). The one or more delivery intention options may be used by the user to set the delivery intention. For example, the delivery intention that the user wants to set is the form intention. In this case, the terminal device 100 may detect an operation (for example, a tap operation) performed by the user on the form intention option illustrated in FIG. 4C, and in response to the operation, the terminal device 100 may set the delivery intention to the form intention illustrated in FIG. 4D.

The delivery intention set by the user may be a delivery intention specified by the advertiser.

It should be noted that, in this embodiment of this application, that the user sets only one delivery intention is used as an example, and should not constitute a limitation on this application. In some examples, the user may alternatively set a plurality of delivery intentions. For example, the user may select the plurality of delivery intentions in the window 415 shown in FIG. 4C, to set the plurality of delivery intentions.

With reference to FIG. 4D, the user may further set the system function. For example, the terminal device 100 may detect an operation (for example, a tap operation) performed by the user on an option 414, and in response to the operation, the terminal device may display a window 416 illustrated in FIG. 4E.

With reference to FIG. 4E, the window 416 may include one or more system function options (for example, system function options such as the delivery intention embedding, delivery intention correction, and delivery intention extraction). The one or more system function options may be used by the user to set the system function. For example, the system function that the user wants to set is the delivery intention embedding. In this case, the terminal device 100 may detect an operation (for example, a tap operation) performed by the user on the delivery intention embedding option illustrated in FIG. 4E, and in response to the operation, the terminal device 100 may set the system function to the delivery intention embedding illustrated in FIG. 4F.

The system function may be a function of performing the delivery intention embedding, the delivery intention correction, the delivery intention extraction, or the like on the advertisement picture-copy based on the delivery intention set by the user. For example, the system function set by the user is the delivery intention embedding. In this case, in a subsequent step, an element and/or text related to the delivery intention set by the user may be embedded in the advertisement picture-copy.

It is easy to understand that, because a scenario corresponding to the embodiment shown in FIG. 4A is the delivery intention embedding scenario, the system function set by the user may be the delivery intention embedding.

S403 and S404: The terminal device 100 detects an operation of inputting an original advertisement picture-copy and loading the advertisement material library by the user, and in response to the operation, the terminal device 100 displays the original advertisement picture-copy and the advertisement material library.

With reference to FIG. 4F, the terminal device 100 may support the user in inputting the original advertisement picture-copy and loading the advertisement material library in the advertisement picture-copy display and interaction area and the advertisement material display and interaction area respectively. The original advertisement picture-copy and the advertisement material library may be pre-stored in the terminal device 100. A time sequence of inputting the original advertisement picture-copy and loading the advertisement material library by the user is not limited in embodiments of this application.

For example, the user first inputs the original advertisement picture-copy. The user may input the advertisement picture-copy by operating an option 411 illustrated in FIG. 4F. For example, the terminal device 100 may detect an operation (for example, a tap operation) performed by the user on the option 411. In response to the operation, the terminal device 100 may display a file list interface (not shown in the figure). The interface may include a file corresponding to the original advertisement picture-copy. Further, the terminal device 100 may detect an operation of selecting the file corresponding to the original advertisement picture-copy by the user. In response to the operation, the terminal device 100 may input and display the original advertisement picture-copy in the advertisement picture-copy display and interaction area illustrated in FIG. 4G.

With reference to FIG. 4G, the original advertisement picture-copy may include an original advertisement picture 417 and an original advertisement copy 418 (for example, “XXXXXXXX”).

Still with reference to FIG. 4G, for example, the user may further load the advertisement material library by operating the option 412 in the advertisement material display and interaction area. For example, the terminal device 100 may detect an operation (for example, a tap operation) performed by the user on the option 412. In response to the operation, the terminal device 100 may display a file list interface (not shown in the figure). The interface may include a file corresponding to the advertisement material library. Further, the terminal device 100 may detect an operation of selecting the file corresponding to the advertisement material library by the user. In response to the operation, the terminal device 100 may load and display the advertisement material library in the advertisement material display and interaction area illustrated in FIG. 4H.

The advertisement material library may be used to provide various materials for editing the advertisement picture-copy, for example, a picture, a control/button, an icon, an edit box, an artistic word, and text.

With reference to FIG. 4H, a part or all of the materials in the advertisement material library may be displayed in the advertisement material display and interaction area. When the part of the materials are displayed, the user may drag a slider bar or tap a pull-up/drop-down option to view another material that is not displayed.

It should be noted that, in FIG. 4F and FIG. 4G, only an example of a possible implementation of inputting the original advertisement picture-copy and loading the advertisement material library is described. In some other embodiments of this application, an implementation of inputting the original advertisement picture-copy and loading the advertisement material library may be another implementation. This is not limited in embodiments of this application.

It should be noted that a time sequence of performing the foregoing steps S401 and S402 and the foregoing steps S403 and S404 is not limited in embodiments of this application. The foregoing steps S401 and S402 may be performed before the foregoing steps S403 and S404, or may be performed after the foregoing steps S403 and S404.

In some examples, the terminal device 100 may further display an OK control in the function/parameter setting area, for example, an OK control shown in FIG. 4H. In this way, after the user selects the delivery intention and the system function, the user may tap the OK control, to indicate that the user sets the delivery intention and the system function. Further, the terminal device 100 may obtain information about the delivery intention and the system function that have been set by the user, and perform a subsequent operation.
S405: The terminal device 100 sends a message 1 to the server 200, where the message includes information about the original advertisement picture-copy, the advertisement material library, the delivery intention, and the system function.

Specifically, after the delivery intention is set, the system function is set, the original advertisement picture-copy is input, and the advertisement material library is loaded, the terminal device 100 may send the message 1 to the server 200. The message may include the information about the original advertisement picture-copy, the advertisement material library, the delivery intention, and the system function.

In this way, the terminal device 100 may upload the original advertisement picture-copy and the advertisement material library to the server 200, so that the server 200 can perform a subsequent step, to complete the delivery intention embedding.

It should be noted that the foregoing step S405 may be automatically triggered and performed by the terminal device 100 (for example, the foregoing step S405 is automatically triggered and performed after the user sets the delivery intention, sets the system function, inputs the original advertisement picture-copy, and loads the advertisement material library), or may be performed by the terminal device 100 through triggering by a user operation (for example, the terminal device 100 may display an option for sending the message 1 to the server 200, and the terminal device 100 may perform the foregoing step S405 after detecting an operation of tapping the option by the user). This is not limited in embodiments of this application.

In some examples, the server 200 may also pre-store the advertisement material library provided by the user of the terminal device 100. In this case, alternatively, the message 1 may not include the information about the advertisement material library. In some other examples, when the advertisement material library is updated, the message 1 may include the information about the advertisement material library, so that the server 200 can update the advertisement material library in a timely manner.

S406: When determining, based on the message 1, that a delivery intention-related element and/or delivery intention-related text are/is missing in the original advertisement picture-copy, the server 200 embeds the missing delivery intention-related element and/or text in the original advertisement picture-copy, to generate a new advertisement picture-copy.

Specifically, after receiving the message 1 sent by the terminal device 100, the server 200 may learn of the delivery intention and the system function based on the message 1. Because the system function is the delivery intention embedding, the server 200 may determine, based on information that is included in the message 1 and that is about the original advertisement picture-copy, whether the delivery intention-related element and/or text are/is missing in the original advertisement picture-copy. For example, the server 200 may respectively locate the delivery intention-related element and a delivery intention-related text segment in an original advertisement picture and an original advertisement copy. When the server 200 determines that the delivery intention-related element is missing (that is, a related element corresponding to the delivery intention set by the user is missing) in the original advertisement picture, the server 200 may search the advertisement material library for the delivery intention-related element, and embed the delivery intention-related element in an appropriate area (for example, a background area or an instance-free area) in the original advertisement picture. When the server 200 determines that the delivery intention-related text segment is missing (that is, a related text segment corresponding to the delivery intention set by the user is missing) in the original advertisement copy, the server 200 may express, as a copy, the delivery intention- related element that has been embedded in the advertisement picture, then embed the element in the original advertisement copy, and fine-tune the element, to generate a semantically continuous new advertisement copy. So far, a new advertisement picture-copy is generated.

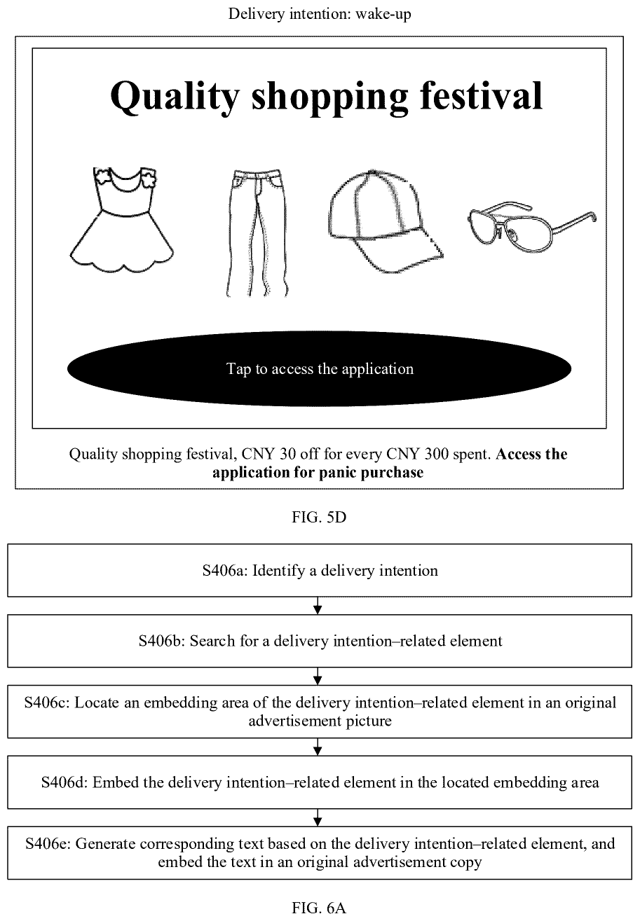

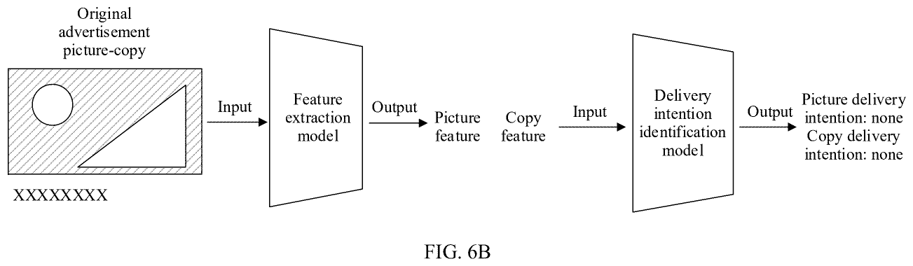

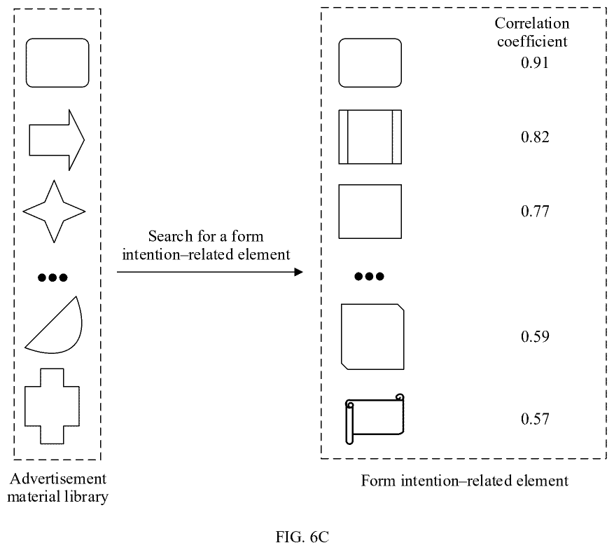

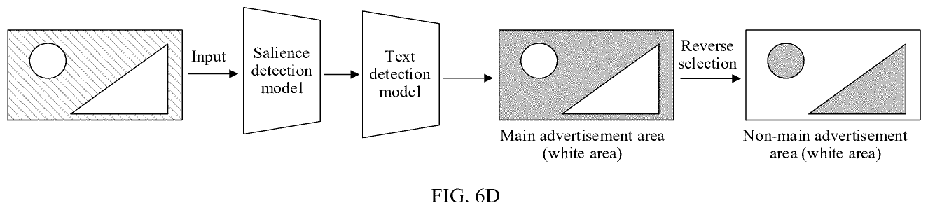

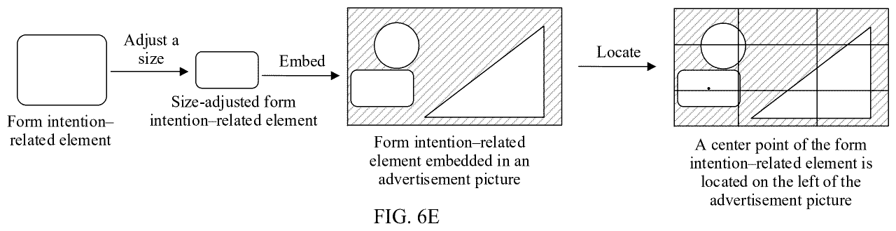

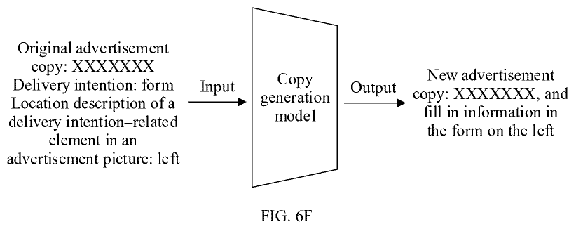

There may be a plurality of specific implementations of the foregoing step S406. This is not limited in embodiments of this application. A possible implementation of the foregoing step S406 is subsequently described in detail in an embodiment illustrated in FIG. 6A to FIG. 6F. Details are not described herein.

S407: The server 200 sends a message 2 to the terminal device 100, where the message includes information about the new advertisement picture-copy.

Specifically, after generating the new advertisement picture-copy, the server 200 may send the message 2 to the terminal device 100. The message may include the information about the new advertisement picture-copy, so that the terminal device 100 can display the new advertisement picture-copy based on the information about the new advertisement picture-copy.

S408: The terminal device 100 displays the new advertisement picture-copy based on the message 2.

Specifically, after receiving the message 2 sent by the server 200, the terminal device 100 may display the new advertisement picture-copy based on the message 2.

For example, with reference to FIG. 4I, an advertisement picture-copy displayed in the advertisement picture-copy display and interaction area may be the generated new advertisement picture-copy. Because the delivery intention set by the user is the form intention, and the system function set by the user is the delivery intention embedding, when the server 200 determines that a form intention-related element is missing in the original advertisement picture (for example, the advertisement picture 417 illustrated in FIG. 4G), the server 200 may embed the form intention-related element (for example, compared with the advertisement picture 417 illustrated in FIG. 4G, a newly added rectangular element in an advertisement picture 419 illustrated in FIG. 4I) in the original advertisement picture, to generate the new advertisement picture (for example, the advertisement picture 419 illustrated in FIG. 4I). When the server 200 determines that a form intention-related text segment is missing in the original advertisement copy (for example, the advertisement copy 418 illustrated in FIG. 4G), the server 200 may embed, in the original advertisement copy (for example, the advertisement copy 418 illustrated in FIG. 4G), a text segment obtained after the form intention-related element is expressed as the copy (for example, compared with the advertisement copy 418 illustrated in FIG. 4G, the newly added text segment “Fill in information in the form on the left” in an advertisement copy 420 illustrated in FIG. 4I), to generate the new advertisement copy (for example, the advertisement copy 420 illustrated in FIG. 4I).

In this embodiment of this application, an example in which the method shown in FIG. 4A is jointly completed by the terminal device 100 and the server 200 is used. In some examples, the method shown in FIG. 4A may alternatively be independently completed by the terminal device 100 without participation of the server 200. It is easy to understand that, in this case, step S406 in FIG. 4A may be performed by the terminal device 100, and interaction steps (for example, step S405 and step S407 in FIG. 4A) between the terminal device 100 and the server 200 may also be omitted.

Through implementation of the method shown in FIG. 4A, when the element and/or the text related to the delivery intention specified by the advertiser is missing in the original advertisement picture-copy, the delivery intention-related element can be embedded in the original advertisement picture to generate the new advertisement picture, and the delivery intention-related embedded element can be expressed as the copy and then embedded in the original advertisement copy to generate the new advertisement copy. In this way, the delivery intention- related element in the new advertisement picture can be intuitively reflected in an expression of the new advertisement copy, so that core information such as the delivery intention of the advertisement is conveyed with picture-copy consistency.

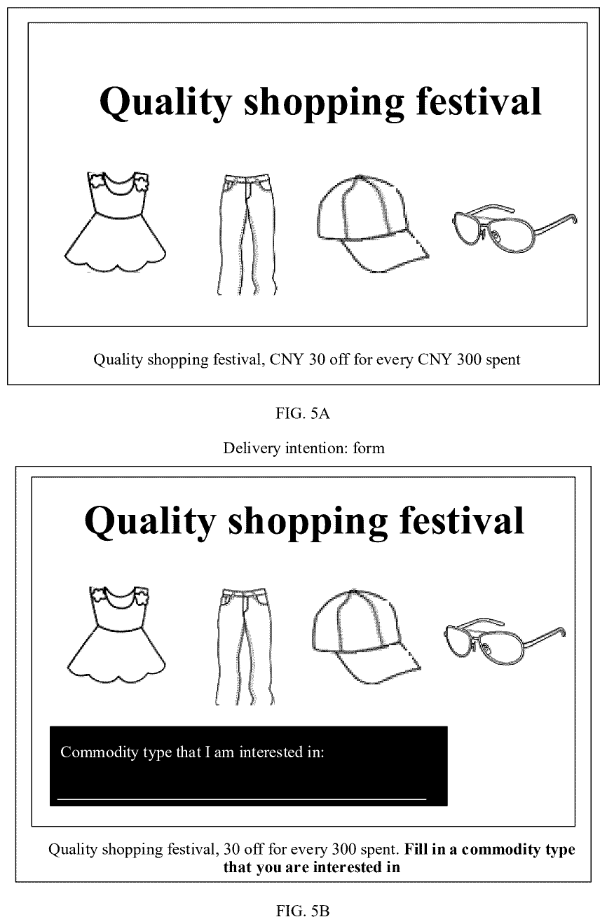

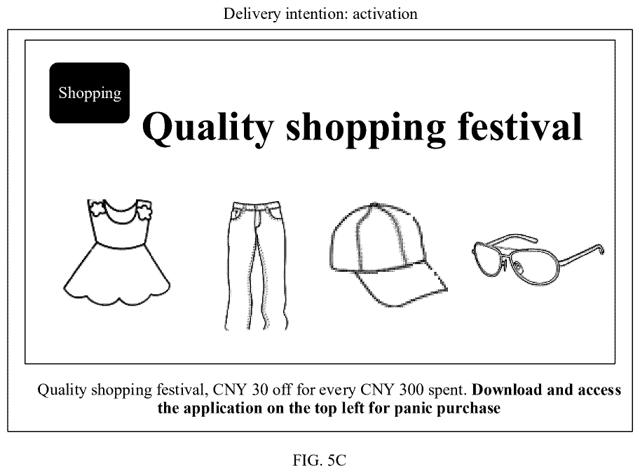

With reference to FIG. 5A to FIG. 5D, the following describes examples of specific application scenarios of embedding delivery intentions in an original advertisement picture-copy to generate new advertisement picture-copies.

A shopping advertisement delivery application scenario is used as an example. It is assumed that an advertisement picture-copy illustrated in FIG. 5A is the original advertisement picture-copy.

For example, it is assumed that a delivery intention set by a user is a form intention, and a system function set by the user is delivery intention embedding. In this case, the generated new advertisement picture-copy may be, for example, an advertisement picture-copy illustrated in FIG. 5B. It can be learned that a form intention-related element (for example, a form of “Commodity type that I am interested in: ______”) is embedded in a new advertisement picture, and a text segment (for example, “Fill in a commodity type that you are interested in”) obtained after the form intention-related element is expressed as a copy is embedded in a new advertisement copy. In this way, if the terminal device 100 detects that the user fills in, in the form, information about a commodity type that the user is interested in, the terminal device 100 may recommend a commodity of a related type in an application based on the information, to improve a purchase power of the user.

For example, it is assumed that a delivery intention set by a user is an activation intention, and a system function set by the user is delivery intention embedding. In this case, the generated new advertisement picture-copy may be, for example, an advertisement picture-copy illustrated in FIG. 5C. It can be learned that an activation intention-related element (for example, an icon of a “shopping application”) is embedded in a new advertisement picture, and a text segment (for example, “Download and access the application on the top left for panic purchase”) obtained after the activation intention-related element is expressed as a copy is embedded in a new advertisement copy. In this way, if the terminal device 100 detects that the user taps the activation intention-related element, namely, the icon of the “shopping application”, the terminal device 100 can download and install the shopping application, and after completing the installation, can automatically start the shopping application, so that the user can purchase a commodity in the shopping application.

For example, it is assumed that a delivery intention set by a user is a wake-up intention, and a system function set by the user is delivery intention embedding. In this case, the generated new advertisement picture-copy may be, for example, an advertisement picture-copy illustrated in FIG. 5D. It can be learned that a wake-up intention-related element (for example, an option/button “Tap to access the application”) is embedded in a new advertisement picture, and a text segment (for example, “Access the application for panic purchase”) obtained after the wake-up intention-related element is expressed as a copy is embedded in a new advertisement copy. In this way, if the terminal device 100 detects that the user taps the wake-up intention-related element, namely, the option/button “Tap to access the application”, the terminal device 100 can automatically start the installed shopping application corresponding to the advertisement picture-copy, so that the user can purchase a commodity in the shopping application program.

It should be noted that the foregoing uses merely the form intention, the activation intention, and the wake-up intention as examples to describe specific application scenarios of embedding the delivery intentions in the advertisement picture-copy. The delivery intention may alternatively be another intention (for example, next-day retention, payment, registration, or customization). This is not limited in embodiments of this application.

With reference to FIG. 6A to FIG. 6F, the following describes an example of a possible implementation of step S406 shown in FIG. 4A. With reference to FIG. 6A, FIG. 6A illustrates a specific implementation process of embedding the delivery intention in the advertisement picture-copy. The process may be performed by the terminal device 100 or the server 200. The following describes specific steps of the process in detail by using an example in which the process is performed by the server 200.
S406a: The server 200 identifies the delivery intention.

Specifically, the server 200 may identify the delivery intention-related element in the original advertisement picture and the delivery intention-related text segment in the original advertisement copy through a related algorithm model, to determine whether a delivery intention-related element and/or delivery intention-related text that are/is strongly related to the delivery intention set by the user are/is missing in the original advertisement picture-copy. If the delivery intention-related element and/or text that are/is strongly related to the delivery intention set by the user, the server 200 may perform a subsequent step S406b.

For example, with reference to FIG. 6B, the server 200 may input the original advertisement picture-copy into a feature extraction model, so that the server 200 can obtain a picture feature and a copy feature of the original advertisement picture-copy. Further, the server 200 may input information such as the picture feature and the copy feature into a delivery intention identification model, so that the server 200 can identify the delivery intention-related element in the original advertisement picture and the delivery intention-related text segment in the original advertisement copy. Further, the server 200 may determine, based on the identified delivery intention-related element, the identified delivery intention-related text segment in the original advertisement copy, and the delivery intention set by the user, whether the delivery intention-related element and/or text that are/is strongly related to the delivery intention set by the user is missing in the original advertisement picture-copy. For example, if the identified delivery intention-related element does not include an element that is strongly related to the delivery intention set by the user, it indicates that the element related to the delivery intention set by the user is missing in the original advertisement picture, and if the identified delivery intention-related text segment does not include a text segment (or referred to as semantics/an expression) that is strongly related to the delivery intention set by the user, it indicates that the text segment-related to the delivery intention set by the user is missing in the original advertisement copy.
S406b: The server 200 searches for the delivery intention-related element.

Specifically, the server 200 may search the advertisement material library for the delivery intention-related element. The delivery intention-related element herein may be the element related to the delivery intention set by the user. The server 200 may find one or more delivery intention-related elements. When the server 200 finds a plurality of delivery intention-related elements, the server 200 may select one of the plurality of delivery intention-related elements as a delivery intention-related element to be subsequently embedded in the original advertisement picture. The server 200 may select the element in a plurality of manners, including but not limited to the following manners:
1. Select an element with a largest coefficient of correlation with the delivery intention.
2. Randomly select one of elements in a search result.
3. Randomly select one of elements whose coefficients of correlation with the delivery intention are greater than a threshold t.

For example, with reference to FIG. 6C, it is assumed that the delivery intention set by the user is the form intention. In this case, the server 200 may search the advertisement material library for the form intention-related element. When the server 200 finds a plurality of form intention-related elements, the server 200 may sort the elements based on correlations (represented by correlation coefficients) between the elements and the delivery intention set by the user, and may select one of the elements as a delivery intention-related element to be subsequently embedded in the original advertisement picture, for example, may select an element (for example, a rectangular element that is illustrated in FIG. 6C and whose correlation coefficient is 0.91) with a largest coefficient of correlation with the delivery intention set by the user.
S406c: The server 200 locates an embedding area of the delivery intention-related element in the original advertisement picture.

Specifically, the server 200 may locate the embedding area of the delivery intention-related element in the original advertisement picture through a related algorithm model, so that the found delivery intention-related element can be subsequently embedded in the original advertisement picture.

For example, with reference to FIG. 6D, the server 200 may determine a main advertisement area (for example, a white area) in the original advertisement picture through a saliency detection model and a text detection model, and determine a non-main advertisement area (for example, a white area, namely, a background area or a word-free area) in the original advertisement picture in a reverse selection manner. The main advertisement area may be used as the embedding area of the delivery intention-related element, and is used to embed the delivery intention-related element. In other words, the server 200 may embed the delivery intention-related element in a location in the embedding area.

It should be noted that a time sequence of performing the foregoing step S406b and the foregoing step S406c is not limited in embodiments of this application. The foregoing step S406b may be performed before the foregoing step S406c, or may be performed after the foregoing step S406c. The foregoing step S406b and the foregoing step S406c may alternatively be performed simultaneously.
S406d: The server 200 embeds the delivery intention-related element in the located embedding area.

In some examples, before the server 200 embeds the delivery intention-related element in the original advertisement picture, the server 200 may first evaluate a size of the delivery intention-related element. If the delivery intention-related element has an appropriate size, may be completely embedded in the located embedding area, and does not block other content (for example, content in the main advertisement area) in the original advertisement picture, the server 200 may directly embed the delivery intention-related element in the located embedding area. If the delivery intention-related element has an excessively large size, and cannot be completely embedded in the located embedding area, the server 200 may reduce the size of the delivery intention-related element (for example, reduce a size of the form intention-related element in FIG. 6E), for example, reduce the size to a size in which the main advertisement area is not covered. Further, the server 200 may embed the size-reduced delivery intention-related element in the located embedding area.

In some examples, after embedding the delivery intention-related element in the located embedding area, the server 200 may further record information about the location in which the delivery intention-related element is embedded in the original advertisement picture, to subsequently generate the new advertisement copy. A description of the location information may be, for example, a top left, an upper part, a top right, a left, a center, a right, a bottom left, a lower part, or a bottom right. For example, with reference to FIG. 6E, the advertisement picture is divided into nine-box grids. The location information may be a location of a center point of the delivery intention-related element. It can be learned that a center point of the form intention-related element shown in FIG. 6E is located on the left of the advertisement picture.
S406e: The server 200 generates corresponding text based on the delivery intention-related element, and embeds the text in the original advertisement copy.

Specifically, the server 200 may generate the corresponding text (namely, the text segment related to the delivery intention set by the user) through a related algorithm model based on the delivery intention-related element, and embed the text in the original advertisement copy.

For example, with reference to FIG. 6F, the server 200 may input the original advertisement copy (for example, “XXXXXXXX”), the delivery intention (for example, the form intention set by the user), and the location description (for example, the “left”) of the delivery intention-related element in the advertisement picture into a copy generation model, to generate the delivery intention-related text segment (for example, “Fill in information in the form on the left”), and embed the text segment in the original advertisement copy, so as to output the new advertisement copy (for example, “XXXXXXXX, and fill in information in the form on the left”) that includes the delivery intention-related text segment.

It should be noted that the foregoing uses merely an example in which the new advertisement copy is generated based on a template-free copy generation model, but is not limited thereto. The new advertisement copy may alternatively be generated in another manner, for example, generated based on a copy template.

This is not limited in embodiments of this application.

### Embodiment 2: Delivery Intention Correction

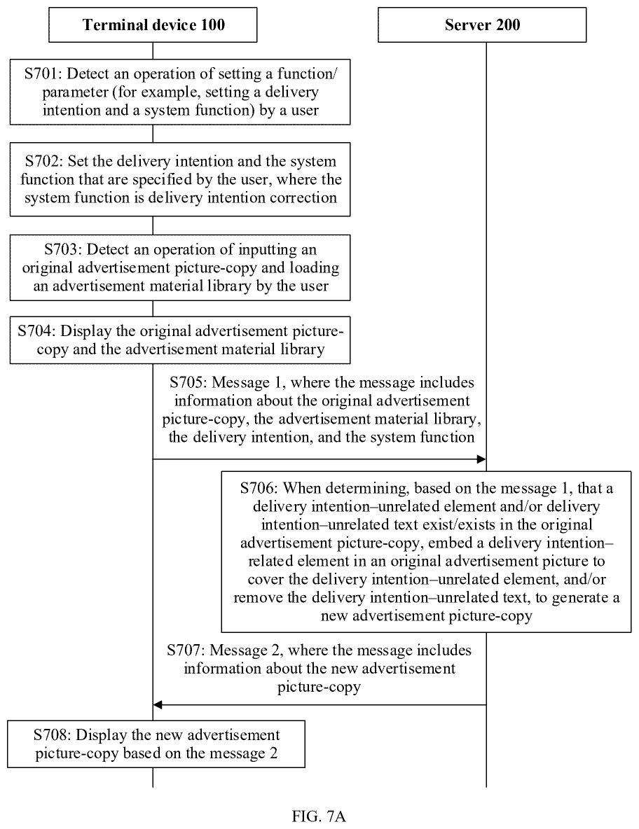

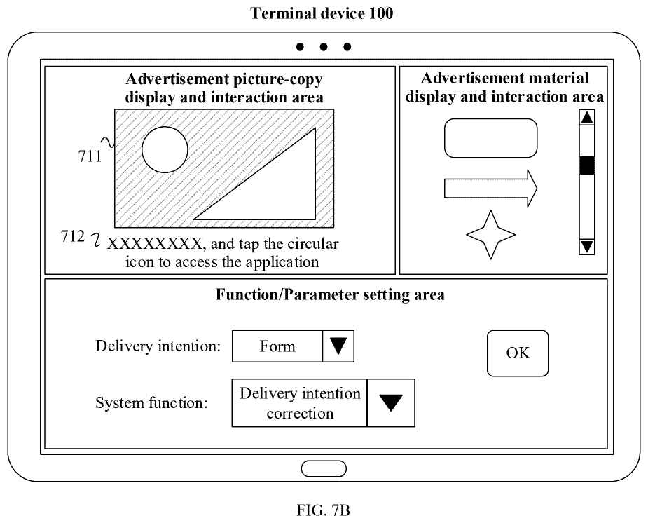

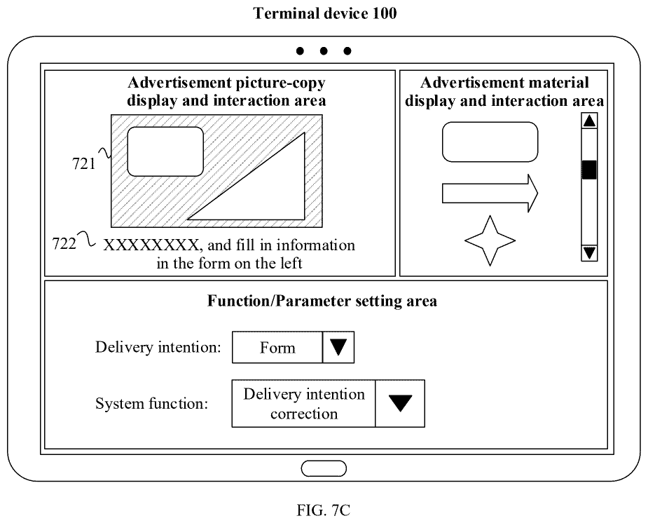

FIG. 7A illustrates a specific procedure of an advertisement generation method in a delivery intention correction scenario according to an embodiment of this application.

As shown in FIG. 7A, the method may be applied to a communication system including the terminal device 100 and the server 200.

Similar to that in Embodiment 1, the terminal device 100 may also provide an interactive interface. For descriptions of the interactive interface, refer to related content in Embodiment 1. Details are not described herein again.

With reference to FIG. 7A to FIG. 7C, the following describes in detail specific steps of the delivery intention correction.
S701 and S702: The terminal device 100 detects an operation of setting a function/parameter (for example, setting a delivery intention and a system function) by a user, and in response to the operation, the terminal device 100 sets the delivery intention and the system function that are specified by the user, where the system function is the delivery intention correction.

It is easy to understand that, because a scenario corresponding to the embodiment shown in FIG. 7A is the delivery intention correction scenario, the system function set by the user may be the delivery intention correction. In this way, in a subsequent step, an element and/or text unrelated to the delivery intention set by the user in an original advertisement picture-copy may be corrected.

The foregoing steps S701 and S702 are similar to step S401 and step S402 shown in FIG. 4A. For a specific execution process thereof, refer to related word descriptions of step S401 and step S402 shown in FIG. 4A. Details are not described herein again.
S703 and S704: The terminal device 100 detects an operation of inputting the original advertisement picture-copy and loading an advertisement material library by the user, and in response to the operation, the terminal device 100 displays the original advertisement picture-copy and the advertisement material library.

The foregoing steps S703 and S704 are similar to step S403 and step S404 shown in FIG. 4A. For a specific execution process thereof, refer to related word descriptions of step S403 and step S404 shown in FIG. 4A. Details are not described herein again.

For example, with reference to FIG. 7B, after performing the foregoing steps S701 to S704, the terminal device 100 may display the original advertisement picture-copy in an advertisement picture-copy display and interaction area. The original advertisement picture-copy may include an original advertisement picture 711 and an original advertisement copy 712 (for example, “XXXXXXXX, and tap the circular icon to access the application”). The terminal device 100 may further display a part or all of materials in the advertisement material library in an advertisement material display and interaction area. When a part of the materials are displayed, the user may drag a slider bar or tap a pull-up/drop-down option to view another material that is not displayed. The terminal device 100 may further display, in a function/parameter setting area, the delivery intention (for example, a “form” intention) and a system function (for example, the “delivery intention correction”) that are set by the user.

In some examples, the terminal device 100 may further display an OK control in the function/parameter setting area, for example, an OK control shown in FIG. 7B. In this way, after the user selects the delivery intention and the system function, the user may tap the OK control, to indicate that the user sets the delivery intention and the system function. Further, the terminal device 100 may obtain information about the delivery intention and the system function that have been set by the user, and perform a subsequent operation.
S705: The terminal device 100 sends a message 1 to the server 200, where the message includes information about the original advertisement picture-copy, the advertisement material library, the delivery intention, and the system function.

Specifically, after the delivery intention is set, the system function is set, the original advertisement picture-copy is input, and the advertisement material library is loaded, the terminal device 100 may send the message 1 to the server 200. The message may include the information about the original advertisement picture-copy, the advertisement material library, the delivery intention, and the system function.

In this way, the terminal device 100 may upload the original advertisement picture-copy and the advertisement material library to the server 200, so that the server 200 can perform a subsequent step, to complete the delivery intention correction.

It should be noted that the foregoing step S705 may be automatically triggered and performed by the terminal device 100 (for example, the foregoing step S705 is automatically triggered and performed after the user sets the delivery intention, sets the system function, inputs the original advertisement picture-copy, and loads the advertisement material library), or may be performed by the terminal device 100 through triggering by a user operation (for example, the terminal device 100 may display an option for sending the message 1 to the server 200, and the terminal device 100 may perform the foregoing step S705 after detecting an operation of tapping the option by the user). This is not limited in embodiments of this application.

In some examples, the server 200 may also pre-store the advertisement material library provided by the user of the terminal device 100. In this case, alternatively, the message 1 may not include the information about the advertisement material library. In some other examples, when the advertisement material library is updated, the message 1 may include the information about the advertisement material library, so that the server 200 can update the advertisement material library in a timely manner.
S706: When determining, based on the message 1, that the delivery intention-unrelated element and/or text exist/exists in the original advertisement picture-copy, the server 200 embeds a delivery intention-related element in an original advertisement picture to cover the delivery intention-unrelated element, and/or removes the delivery intention-unrelated text, to generate a new advertisement picture-copy.

Specifically, after receiving the message 1 sent by the terminal device 100, the server 200 may learn of the delivery intention and the system function based on the message 1. Because the system function is the delivery intention correction, the server 200 may determine, based on information that is included in the message 1 and that is about the original advertisement picture-copy, whether the delivery intention-unrelated element and/or text (which may also be referred to as an element and/or text related to an incorrect/interfering delivery intention, namely, an element and/or text unrelated to the delivery intention set by the user) exist/exists in the original advertisement picture-copy. When the server 200 determines that the delivery intention-unrelated element exists in the original advertisement picture, the server 200 may search the advertisement material library for the delivery intention-related element (namely, an element related to the delivery intention set by the user), and embed the delivery intention-related element in the original advertisement picture to cover the delivery intention-unrelated element. When the server 200 determines that a delivery intention-unrelated text segment exists in an original advertisement copy, the server 200 may remove the delivery intention-unrelated text segment from the original advertisement copy, express, as a copy, the delivery intention-related element that has been embedded in the advertisement picture, then embed the element in the original advertisement copy, and fine-tune the element, to generate a semantically continuous new advertisement copy. So far, a new advertisement picture-copy is generated.

In some examples, the server 200 may alternatively remove the delivery intention-unrelated element from the original advertisement picture, instead of covering the delivery intention-unrelated element with the delivery intention-related element. In this case, an embedding area of the delivery intention-related element may no longer be an area in which the delivery intention-unrelated element is located, but may be any area in a non-main advertisement area in the advertisement picture. The embedding of the delivery intention-related element is similar to that in the delivery intention embedding process described in Embodiment 1. For details, refer to the foregoing related content. Details are not described herein again.

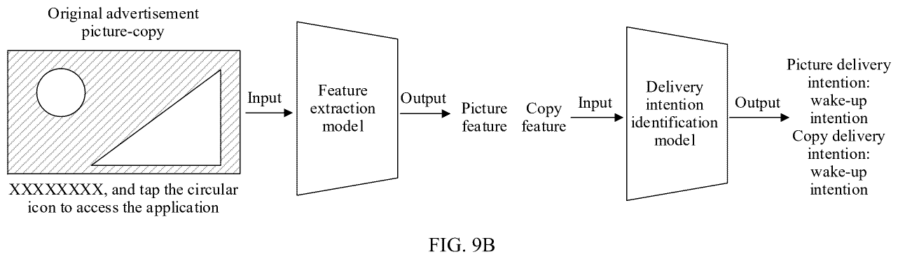

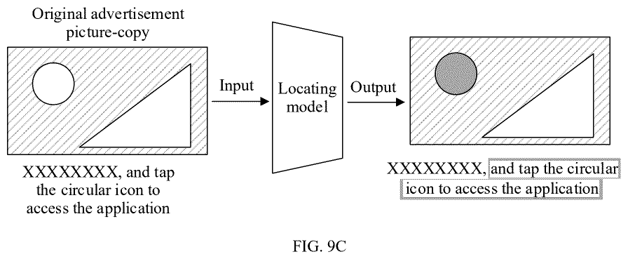

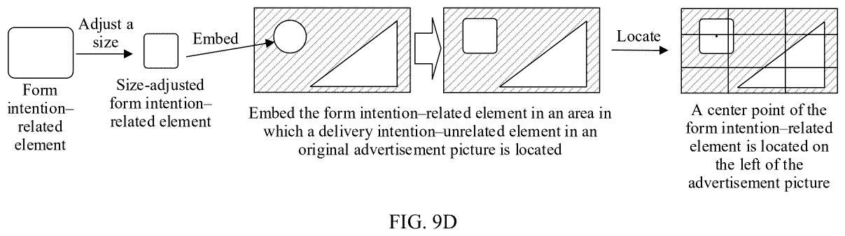

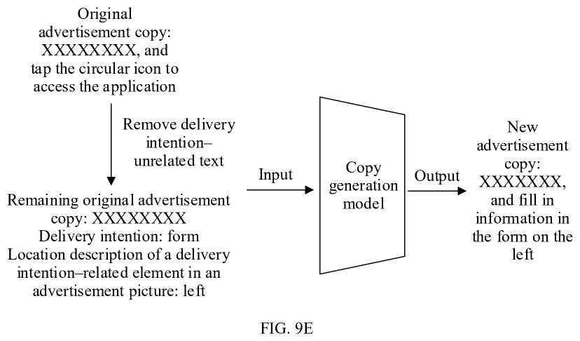

There may be a plurality of specific implementations of the foregoing step S706. This is not limited in embodiments of this application. A possible implementation of the foregoing step S706 is subsequently described in detail in an embodiment illustrated in FIG. 9A to FIG. 9E. Details are not described herein.
S707: The server 200 sends a message 2 to the terminal device 100, where the message includes information about the new advertisement picture-copy.

Specifically, after generating the new advertisement picture-copy, the server 200 may send the message 2 to the terminal device 100. The message may include the information about the new advertisement picture-copy, so that the terminal device 100 can display the new advertisement picture-copy based on the information about the new advertisement picture-copy.
S708: The terminal device 100 displays the new advertisement picture-copy based on the message 2.

Specifically, after receiving the message 2 sent by the server 200, the terminal device 100 may display the new advertisement picture-copy based on the message 2.

For example, with reference to FIG. 7C, an advertisement picture-copy displayed in the advertisement picture-copy display and interaction area may be the generated new advertisement picture-copy. Because the delivery intention set by the user is the form intention, and the system function set by the user is the delivery intention correction, when the server 200 determines that a form intention-unrelated element (for example, a circular element in the original advertisement picture 711 illustrated in FIG. 7B) exists in the original advertisement picture (for example, the original advertisement picture 711 illustrated in FIG. 7B), the server 200 may embed a form intention-related element (for example, a rectangular element in an advertisement picture 721 illustrated in FIG. 7C) in the original advertisement picture to cover the form intention-unrelated element, or embed the form intention-related element in the original advertisement picture and remove the form intention-unrelated element from the original advertisement picture, to generate the new advertisement picture (for example, the advertisement picture 721 illustrated in FIG. 7C). When the server 200 determines that the form intention-unrelated text segment (for example, the text segment “Tap the circular icon to access the application” in the original advertisement copy 712 illustrated in FIG. 7B) exists in the original advertisement copy (for example, the original advertisement copy 712 shown in FIG. 7B), the server 200 may embed, in the original advertisement copy, a text segment obtained after the form intention-related element is expressed as the copy (for example, the text segment “Fill in information in the form on the left” in an advertisement copy 722 illustrated in FIG. 7C), and remove the form intention-unrelated text segment from the original advertisement copy, to generate the new advertisement copy (for example, the advertisement copy 722 illustrated in FIG. 7C).

In this embodiment of this application, an example in which the method shown in FIG. 7A is jointly completed by the terminal device 100 and the server 200 is used. In some examples, the method shown in FIG. 7A may alternatively be independently completed by the terminal device 100 without participation of the server 200. It is easy to understand that, in this case, step S706 in FIG. 7A may be performed by the terminal device 100, and interaction steps (for example, step S705 and step S707 in FIG. 7A) between the terminal device 100 and the server 200 may also be omitted.

Through implementation of the method shown in FIG. 7A, a delivery intention in the advertisement picture-copy can be identified, and a correlation between the delivery intention in the advertisement picture-copy and a delivery intention set by the user can be verified. When the delivery intention-unrelated element and/or text exist/exists in the advertisement picture-copy, the delivery intention-related element (namely, the element related to the delivery intention set by the user) can be embedded in the advertisement picture to cover the delivery intention-unrelated element, or the delivery intention-related element can be embedded in the advertisement picture and the delivery intention-unrelated element can be removed. In addition, the delivery intention-related element that has been embedded in the original advertisement picture can be expressed as the copy and then embedded in the original advertisement copy, and the delivery intention-unrelated text segment in the original advertisement copy can be removed. In this way, a misleading delivery intention in the advertisement picture-copy can be corrected, and the element and/or the text related to the delivery intention set by the user can be embedded in the advertisement picture-copy, so that an advertisement has an intuitive user behavior guidance function. This helps improve advertisement conversion effect.

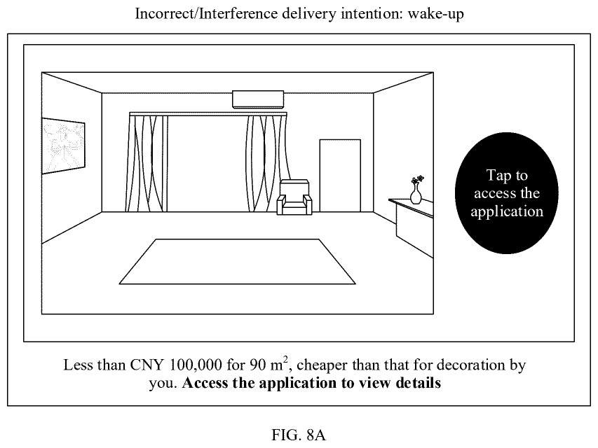

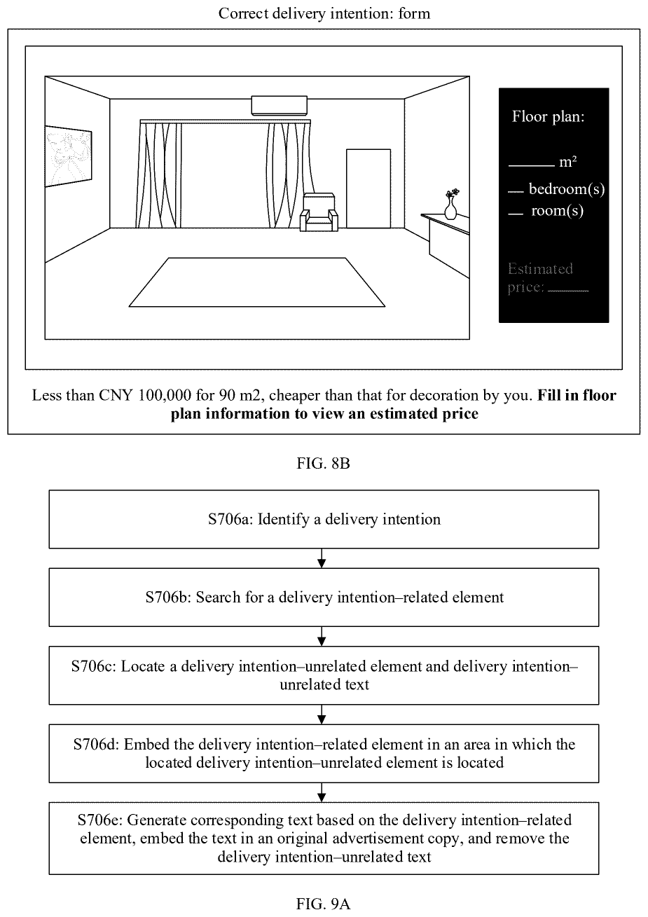

With reference to FIG. 8A and FIG. 8B, the following describes an example of a specific application scenario of performing delivery intention correction on an original advertisement picture-copy to generate a new advertisement picture-copy.

A decoration advertisement delivery application scenario is used as an example. It is assumed that an advertisement picture-copy illustrated in FIG. 8A is the original advertisement picture-copy.

For example, it is assumed that a delivery intention (which may also be referred to as a correct delivery intention) set by a user is a form intention, and a system function set by the user is the delivery intention correction. In this case, a generated new advertisement picture-copy may be, for example, an advertisement picture-copy illustrated in FIG. 8B. It can be learned from FIG. 8A that an incorrect/interfering delivery intention (namely, a delivery intention unrelated to the delivery intention set by the user) exists in the original advertisement picture-copy. For example, a wake-up intention-related element (for example, an option/button “Tap to access the application”) unrelated to the form intention exists in an original advertisement picture, and a wake-up intention-related text segment (for example, the text segment “Access the application to view details”) unrelated to the form intention exists in an original advertisement copy. After the delivery intention correction is performed on the original advertisement picture, it can be learned from FIG. 8B that a form intention-related element (for example, a form “Floor plan: ______ m² ______ bedroom(s) ______ room(s)”) is embedded in the original advertisement picture to cover the wake-up intention-related element/the wake-up intention-related element is removed, and a text segment (for example, “Fill in floor plan information to view an estimated price”) obtained after the form intention-related element is expressed as a copy is embedded in the original advertisement copy, and the wake-up intention-related text segment is removed. In this way, if the terminal device 100 detects that the user fills in floor plan information in the form, the terminal device 100 can display a decoration estimated price based on the information, so that the user learns of the price required for decorating a corresponding floor plan.

It should be noted that the foregoing uses merely an example in which the delivery intention set by the user is the form intention to describe the specific application scenario in which the delivery intention correction is performed on the original advertisement picture-copy to generate the new advertisement picture-copy. The delivery intention set by the user may alternatively be another delivery intention (for example, activation, next-day retention, payment, registration, or customization). This is not limited in embodiments of this application.

With reference to FIG. 9A to FIG. 9E, the following describes an example of a possible implementation of step S706 shown in FIG. 7A. With reference to FIG. 9A, FIG. 9A illustrates a specific implementation process of the delivery intention correction. The process may be performed by the terminal device 100 or the server 200. The following describes specific steps of the process in detail by using an example in which the process is performed by the server 200.
S706a: The server 200 identifies a delivery intention.

Specifically, the server 200 may identify, through a related algorithm model, the delivery intention represented in the original advertisement picture-copy, locate an element (for example, a picture element) that is strongly related to the delivery intention in the original advertisement picture, and locate a text segment that is strongly related to the delivery intention in the original advertisement copy, and then separately calculates consistency between the delivery intention set by the user and each of a delivery intention represented in the original advertisement picture and a delivery intention represented in the original advertisement copy. If the delivery intention represented in the original advertisement picture and the delivery intention represented in the original advertisement copy are inconsistent with the delivery intention set by the user (for example, a consistency coefficient is less than a preset value t), the server 200 may perform a subsequent step S706b.

For example, with reference to FIG. 9B, the server 200 may input the original advertisement picture-copy into a feature extraction model, so that the server 200 can obtain a picture feature and a copy feature of the original advertisement picture-copy. Further, the server 200 may input information such as the picture feature and the copy feature into a delivery intention identification model, so that the server 200 can identify the delivery intention (for example, a wake-up intention) represented in the original advertisement picture-copy. Further, the server 200 may calculate the consistency between the delivery intention set by the user and the delivery intention represented in the original advertisement picture and the delivery intention represented in the original advertisement copy. For example, if the delivery intention set by the user is the form intention, the delivery intention represented in the original advertisement picture is the wake-up intention (for example, the original advertisement picture includes a wake-up intention-related element but does not include the form intention-related element), and the delivery intention represented in the original advertisement copy is the wake-up intention (for example, the original advertisement copy includes a wake-up intention-related text segment but does not include a form intention-related text segment), it indicates that the delivery intentions represented in the original advertisement picture and the delivery intentions represented in the original advertisement copy are inconsistent with the delivery intention set by the user.
S706b: The server 200 searches for the delivery intention-related element.

The delivery intention-related element may be the element related to the delivery intention set by the user.

The foregoing step S706b is similar to step S406b shown in FIG. 6A. For a specific execution process thereof, refer to related word descriptions of step S406b shown in FIG. 6A. Details are not described herein again.
S706c: The server 200 locates the delivery intention-unrelated element and the delivery intention-unrelated text.

Specifically, the server 200 may locate, through a related algorithm model, the delivery intention-unrelated element in the original advertisement picture and the delivery intention-unrelated text in the original advertisement copy, so that the delivery intention-related element may be subsequently embedded in the original advertisement picture (or the delivery intention- unrelated element may be removed), the delivery intention-related element may be expressed as the copy and then embedded in the original advertisement copy, and the delivery intention-unrelated text may be removed.

For example, with reference to FIG. 9C, the server 200 may input the original advertisement picture-copy (or information about an identified delivery intention unrelated to the delivery intention set by the user) into a locating model, and may determine, through the locating model, the delivery intention-unrelated element (for example, a gray circular element that is output by the locating model in FIG. 9C and that is marked in the original advertisement picture) and the delivery intention-unrelated text (for example, the text segment “Tap the circular icon to access the application” that is output by the locating model in FIG. 9C and that is marked in the original advertisement copy) in the original advertisement picture-copy.

It should be noted that a time sequence of performing the foregoing step S706b and the foregoing step S706c is not limited in embodiments of this application. The foregoing step S706b may be performed before the foregoing step S706c, or may be performed after the foregoing step S706c. The foregoing step S706b and the foregoing step S706c may alternatively be performed simultaneously.
S706d: The server 200 embeds the delivery intention-related element in the area in which the located delivery intention-unrelated element is located.

In some examples, before the server 200 embeds the delivery intention-related element in the original advertisement picture, the server 200 may first evaluate a size of the delivery intention-related element. If the size of the delivery intention-related element is appropriate (for example, the delivery intention-related element has the size that is equivalent to a size of the delivery intention-unrelated element, and may just block the delivery intention-unrelated element), the server 200 may directly embed the delivery intention-related element in the area in which the located delivery intention-unrelated element is located. If the size of the delivery intention-related element is inappropriate (for example, the delivery intention-related element has an excessively large size and cannot be integrally embedded in the area in which the located delivery intention-unrelated element is located, or the delivery intention-related element has an excessively small size and cannot block the delivery intention-unrelated element), the server 200 may adjust the size of the delivery intention-related element (for example, reduce a size of the form intention-related element in FIG. 9D). Further, the server 200 may embed the size-adjusted delivery intention-related element in the area in which the located delivery intention-unrelated element is located.

In some examples, after embedding the delivery intention-related element in the area in which the located delivery intention-unrelated element is located, the server 200 may further record information about a location in which the delivery intention-related element is embedded in the original advertisement picture, to subsequently generate the new advertisement copy. A description of the location information may be, for example, a top left, an upper part, a top right, a left, a center, a right, a bottom left, a lower part, or a bottom right. For example, with reference to FIG. 9D, the advertisement picture is divided into nine-box grids. The location information may be a location of a center point of the delivery intention-related element. It can be learned that a center point of the form intention-related element shown in FIG. 9D is located on the left of the advertisement picture.
S706e: The server 200 generates corresponding text based on the delivery intention-related element, embeds the text in the original advertisement copy, and removes the delivery intention-unrelated text.

Specifically, the server 200 may generate the corresponding text (namely, the text segment related to the delivery intention set by the user) through a related algorithm model based on the delivery intention-related element, embed the text in the original advertisement copy, and remove the delivery intention-unrelated text.

For example, with reference to FIG. 9E, the server 200 may remove the delivery intention-unrelated text (for example, “Tap the circular icon to access the application”) from the original advertisement copy (for example, “XXXXXXXX, and tap the circular icon to access the application”), may input a remaining advertisement copy (for example, “ XXXXXXXX”), the delivery intention (for example, the form intention set by the user), and the location description (for example, “left”) of the delivery intention-related element in the advertisement picture into a copy generation model, to generate the delivery intention-related text segment (for example, “Fill in information in the form on the left”), and embed the text segment in the remaining advertisement copy, so as to output the new advertisement copy (for example, “XXXXXXXX, and fill in information in the form on the left”) that includes the delivery intention-related text segment.

It should be noted that the foregoing uses merely an example in which the new advertisement copy is generated based on a template-free copy generation model, but is not limited thereto. The new advertisement copy may alternatively be generated in another manner, for example, generated based on a copy template. This is not limited in embodiments of this application.

It should be noted that, for the generation of the new advertisement copy, the delivery intention-related text segment may be embedded in the remaining advertisement copy after the delivery intention-unrelated text is removed, or the delivery intention-unrelated text may be removed after the delivery intention-related text segment is embedded in the original advertisement copy. This is not limited in embodiments of this application.

### Embodiment 3: Delivery Intention Extraction

FIG. 10A-1 and FIG. 10A-2 illustrate a specific procedure of an advertisement generation method in a delivery intention extraction scenario according to an embodiment of this application.

As shown in FIG. 10A-1 and FIG. 10A-2, the method may be applied to a communication system including the terminal device 100 and the server 200.

Similar to that in Embodiment 1 or Embodiment 2, the terminal device 100 may also provide an interactive interface. For descriptions of the interactive interface, refer to related content in Embodiment 1. Details are not described herein again.

With reference to FIG. 10A-1 to FIG. 10G, the following describes in detail specific steps of the delivery intention extraction.
S1001 and S1002: The terminal device 100 detects an operation of setting a function/parameter (for example, setting a delivery intention and a system function) by a user, and in response to the operation, the terminal device 100 sets the delivery intention and the system function that are specified by the user, where the system function is the delivery intention extraction.

It is easy to understand that, because a scenario corresponding to the embodiment shown in FIG. 10A-1 and FIG. 10A-2 is the delivery intention extraction scenario, the system function set by the user may be the delivery intention extraction. In this way, in a subsequent step, a related element and/or related text that are/is inconsistent with a delivery intention specified by an advertiser may be visually presented to the user, and the user is supported to perform an operation like manually correcting a delivery intention, to update the delivery intention in an advertisement picture-copy.

The foregoing steps S1001 and S1002 are similar to step S401 and step S402 shown in FIG. 4A. For a specific execution process thereof, refer to related word descriptions of step S401 and step S402 shown in FIG. 4A. Details are not described herein again.
S1003 and S1004: The terminal device 100 detects an operation of inputting an original advertisement picture-copy and loading an advertisement material library by the user, and in response to the operation, the terminal device 100 displays the original advertisement picture-copy and the advertisement material library.

The foregoing steps S1003 and S1004 are similar to step S403 and step S404 shown in FIG. 4A. For a specific execution process thereof, refer to related word descriptions of step S403 and step S404 shown in FIG. 4A. Details are not described herein again.

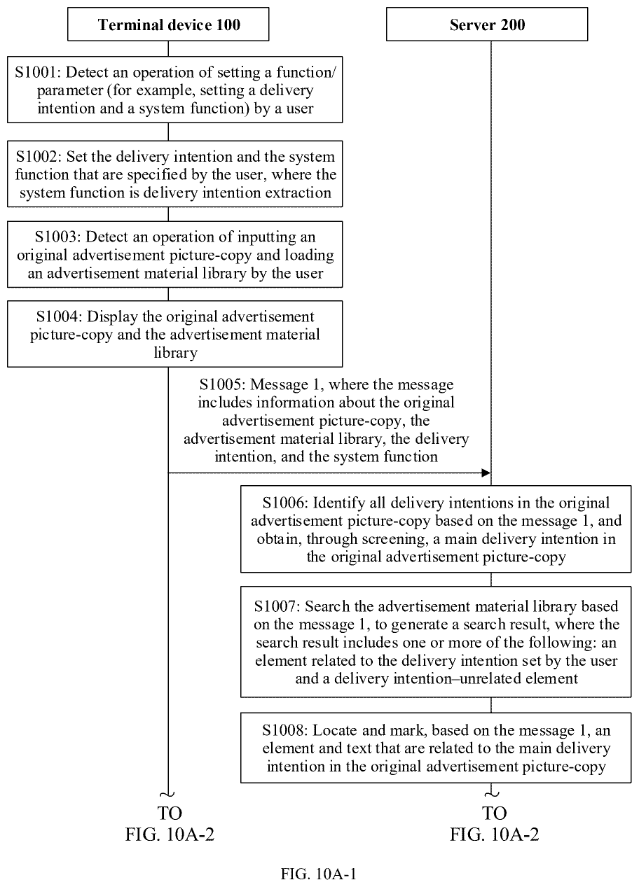

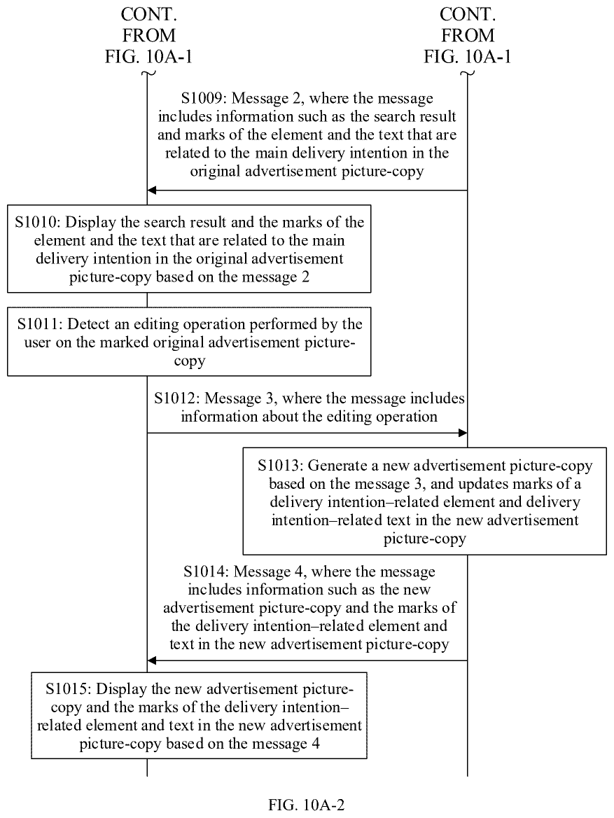

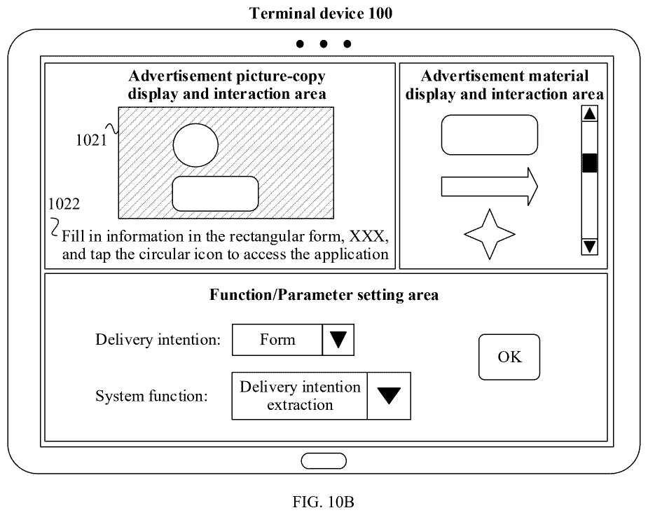

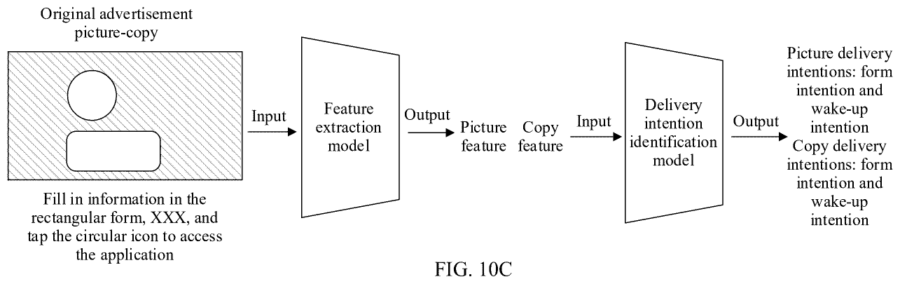

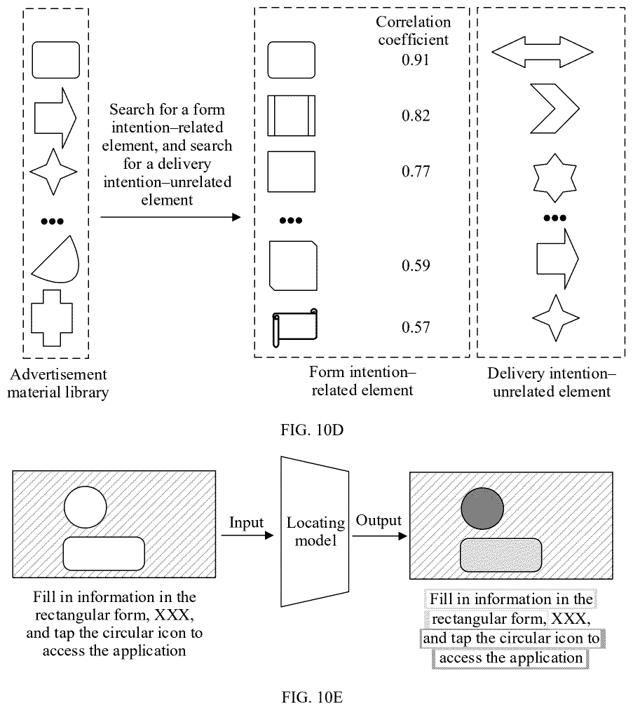

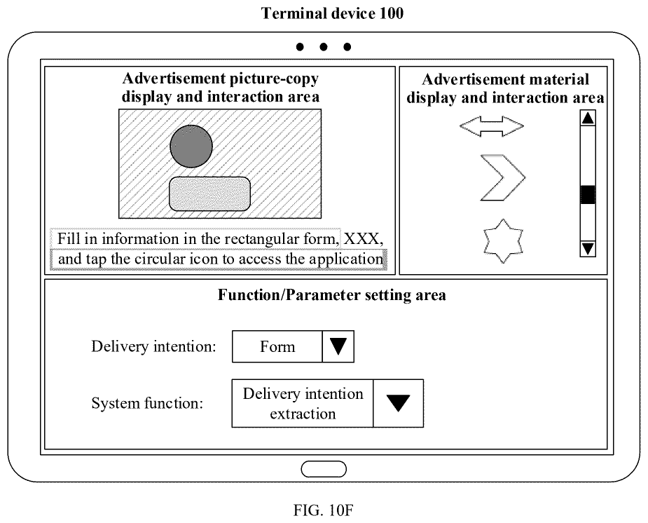

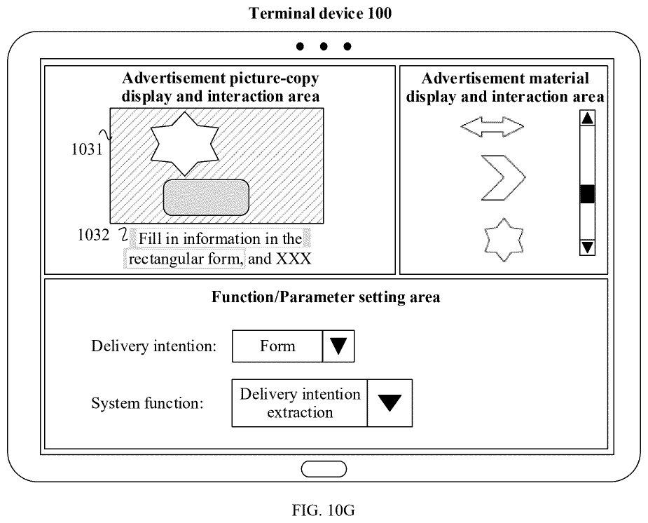

For example, with reference to FIG. 10B, after performing the foregoing steps S1001 to S1004, the terminal device 100 may display the original advertisement picture-copy in an advertisement picture-copy display and interaction area. The original advertisement picture-copy may include an original advertisement picture 1021 and an original advertisement copy 1022 (for example, “Fill in information in the rectangular form, XXX, and tap the circular icon to access the application”). The terminal device 100 may further display a part or all of materials in the advertisement material library in an advertisement material display and interaction area. When a part of the materials are displayed, the user may drag a slider bar or tap a pull-up/drop-down option to view another material that is not displayed. The terminal device 100 may further display, in a function/parameter setting area, the delivery intention (for example, a “form” intention) and a system function (for example, the “delivery intention extraction”) that are set by the user.

In some examples, the terminal device 100 may further display an OK control in the function/parameter setting area, for example, an OK control shown in FIG. 10B. In this way, after the user selects the delivery intention and the system function, the user may tap the OK control, to indicate that the user sets the delivery intention and the system function. Further, the terminal device 100 may obtain information about the delivery intention and the system function that have been set by the user, and perform a subsequent operation.
S1005: The terminal device 100 sends a message 1 to the server 200, where the message includes information about the original advertisement picture-copy, the advertisement material library, the delivery intention, and the system function.

Specifically, after the delivery intention is set, the system function is set, the original advertisement picture-copy is input, and the advertisement material library is loaded, the terminal device 100 may send the message 1 to the server 200. The message may include the information about the original advertisement picture-copy, the advertisement material library, the delivery intention, and the system function.

In this way, the terminal device 100 may upload the original advertisement picture-copy and the advertisement material library to the server 200, so that the server 200 can perform a subsequent step, to complete the delivery intention extraction.

It should be noted that the foregoing step S1005 may be automatically triggered and performed by the terminal device 100 (for example, the foregoing step S1005 is automatically triggered and performed after the user sets the delivery intention, sets the system function, inputs the original advertisement picture-copy, and loads the advertisement material library), or may be performed by the terminal device 100 through triggering by a user operation (for example, the terminal device 100 may display an option for sending the message 1 to the server 200, and the terminal device 100 may perform the foregoing step S1005 after detecting an operation of tapping the option by the user). This is not limited in embodiments of this application.

In some examples, the server 200 may also pre-store the advertisement material library provided by the user of the terminal device 100. In this case, alternatively, the message 1 may not include the information about the advertisement material library. In some other examples, when the advertisement material library is updated, the message 1 may include the information about the advertisement material library, so that the server 200 can update the advertisement material library in a timely manner.
S1006: The server 200 identifies all delivery intentions in the original advertisement picture-copy based on the message 1, and obtains, through screening, a main delivery intention in the original advertisement picture-copy.

Specifically, after receiving the message 1, the server 200 may obtain the original advertisement picture-copy based on the message 1. Further, the server 200 may identify all the delivery intentions in the original advertisement picture-copy through a related algorithm model, and find, in the original advertisement picture-copy, a delivery intention-related element and a delivery intention-related text segment that correspond to each delivery intention. Because a same element or text segment may represent a plurality of delivery intentions, only coefficients of correlation between the element or the text segment and the plurality of delivery intentions are different. If a coefficient of correlation between the element or the text segment and a delivery intention is large, it may be considered that the element or the text segment is strongly related to the delivery intention. A coefficient of correlation between an element or a text segment and a delivery intention may also be referred to as a strength degree d of the delivery intention represented by the element or the text segment. When d is greater than a threshold k preset by the user, it may be considered that the delivery intention represented by the element or the text segment is a main delivery intention (which may also be referred to as a strongly related delivery intention or a strongly limited delivery intention). In this way, the server 200 can obtain, through screening, the main delivery intention in the original advertisement picture-copy.

For example, with reference to FIG. 10C, the server 200 may input the original advertisement picture-copy into a feature extraction model, so that the server 200 can obtain a picture feature and a copy feature of the original advertisement picture-copy. Further, the server 200 may input information such as the picture feature and the copy feature into a delivery intention identification model, so that the server 200 can identify and obtain, through screening, the main delivery intention (for example, a form intention or a wake-up intention) in the original advertisement picture-copy.

It is easy to understand that the main delivery intentions obtained by the server 200 through screening may include both the delivery intention set by the user and an incorrect/interfering delivery intention, or may not include the delivery intention set by the user but include only the incorrect/interfering delivery intention, or may include only the delivery intention set by the user but do not include the incorrect/interfering delivery intention. In the embodiment shown in FIG. 10A-1 and FIG. 10A-2, only an example in which the main delivery intention includes both the delivery intention (for example, the form intention) set by the user and the incorrect/interfering delivery intention (for example, the wake-up intention) is used for description.
S1007: The server 200 searches the advertisement material library based on the message 1, to generate a search result, where the search result includes one or more of the following: an element related to the delivery intention set by the user and a delivery intention-unrelated element.

The delivery intention-unrelated element may be an element that does not represent any delivery intention. In some examples, the delivery intention-unrelated element may be an element like a graphic or an artistic word used to guide a user behavior, for example, an element used to guide the user to fill in a form or perform a tap operation.

A process in which the server 200 searches the advertisement material library for the element related to the delivery intention set by the user is similar to step S406b shown in FIG. 6A. For details, refer to related word descriptions of step S406b shown in FIG. 6A. Details are not described herein again.

In addition to searching the advertisement material library for the element related to the delivery intention set by the user, the server 200 may further search the advertisement material library for the delivery intention- unrelated element.

For example, it is assumed that the delivery intention set by the user is the form intention. With reference to FIG. 10D, the server 200 may search the advertisement material library for a form intention-related element and the delivery intention-unrelated element, to generate a search result including the form intention-related element and the delivery intention-unrelated element.

The found delivery intention-unrelated element and element related to the delivery intention set by the user may be both used to replace an element related to the incorrect/interfering delivery intention in the original advertisement picture-copy.

In this embodiment of this application, the search result may include both the element related to the delivery intention set by the user and the delivery intention-unrelated element, or may include only the element related to the delivery intention set by the user or the delivery intention-unrelated element. It is easy to understand that, in a subsequent step, the user may select an element in the search result as required, to replace the element related to the incorrect/interfering delivery intention in the original advertisement picture-copy. Therefore, when the search result includes both the element related to the delivery intention set by the user and the delivery intention-unrelated element, more options may be provided for the user, which is easier to meet an expectation of the user and improves user experience.

Similar to that in Embodiment 1, with reference to FIG. 10D, the search result generated by the server 200 may further include a coefficient of correlation between the delivery intention-related element and a delivery intention represented by the delivery intention-related element (for example, a coefficient of correlation between a rectangular element and a form intention represented by the rectangular element is 0.91).
S1008: The server 200 locates and marks, based on the message 1, an element and text that are related to the main delivery intention in the original advertisement picture-copy.

Specifically, the server 200 may locate, through a related algorithm model, the element and the text that are related to the main delivery intention in the original advertisement picture-copy. After the locating, the server 200 may further mark the element and the text that are related to the main delivery intention in the original advertisement picture-copy, so that the element and the text that are related to the main delivery intention in the original advertisement picture-copy can be subsequently sent to the terminal device 100, and the user can learn of the element and the text that are related to the main delivery intention in the original advertisement picture-copy.

For example, the server 200 locates and marks, through a locating model, the element and the text that are related to the main delivery intention in the original advertisement picture-copy. With reference to FIG. 10E, the server 200 may input the original advertisement picture-copy (or information about an identified delivery intention unrelated to the delivery intention set by the user) into the locating model, and may locate and mark, through the locating model, elements (for example, a dark gray circular element and a light gray rectangular element that are output by the locating model in FIG. 10E and that are marked in the original advertisement picture) related to the main delivery intention in the original advertisement picture-copy and text (for example, the light gray background text segment “Fill in information in the rectangular form” and the dark gray background text segment “Tap the circular icon to access the application” that are output by the locating model in FIG. 10E and that are marked in the original advertisement copy) related to the main delivery intention.

It should be noted that manners of marking the element and the text that are related to the main delivery intention is not limited in embodiments of this application. The manner of marking the element related to the main delivery intention may include but is not limited to a heat map, a detection box, a contour line, a coordinate value, and the like. The manner of marking the text related to the main delivery intention may include but is not limited to a word color, a word background color, a detection box, text location coordinates, and the like.

It should be noted that a time sequence of performing the foregoing step S1008 and the foregoing step S1007 is not limited in embodiments of this application. The foregoing step S1008 may be performed before the foregoing step S1007, or may be performed after the foregoing step S1007. The foregoing step S1008 and the foregoing step S1007 may alternatively be performed simultaneously.
S1009: The server 200 sends a message 2 to the terminal device 100, where the message includes information such as the search result and marks of the element and the text that are related to the main delivery intention in the original advertisement picture-copy.

Specifically, the server 200 may send the message 2 to the terminal device 100 after searching the advertisement material library based on the message 1, to generate the search result, and locating and marking the element and the text that are related to the main delivery intention in the original advertisement picture-copy. The message includes the information such as the search result, and the element and the text that are related to the main delivery intention in the original advertisement picture-copy, so that the terminal device 100 can subsequently display the search result, and the element and the text that are related to the main delivery intention in the original advertisement picture-copy.
S1010: The terminal device 100 displays the search result and the marks of the element and the text that are related to the main delivery intention in the original advertisement picture-copy based on the message 2.

Specifically, after receiving the message 2 sent by the server 200, the terminal device 100 may display the search result, and the marks of the element and the text that are related to the main delivery intention in the original advertisement picture-copy based on the message 2.

For example, with reference to FIG. 10F, the terminal device 100 may display the search result in the advertisement material display and interaction area. It is easy to understand that, when the search result includes a large quantity of elements, the terminal device 100 may display only a part of the elements. Therefore, the user may drag a slider bar or tap a pull-up/drop-down option to view another element that is not displayed. The terminal device 100 may further display the marked element and text that are related to the main delivery intention in the original advertisement picture-copy in the advertisement picture-copy display and interaction area.

The search result displayed by the terminal device 100 in the advertisement material display and interaction area may include the element related to the delivery intention set by the user and the delivery intention-unrelated element, and may further include a correlation coefficient (not shown in the figure) corresponding to the element related to the delivery intention set by the user.

For example, with reference to FIG. 10F, the terminal device 100 may display the marked original advertisement picture-copy in the advertisement picture-copy display and interaction area. It can be learned of elements (for example, a circular element that represents the wake-up intention and that is marked in a dark gray and a rectangular element that represents the form intention and that is marked in a light gray) related to the main delivery intention in the original advertisement picture-copy and the text (for example, the text segment “Fill in information in the rectangular form” that is marked in a light gray background color and that represents the form intention and the text segment “Tap the circular icon to access the application” that is marked in a dark gray background color and that represents the wake-up intention) related to the main delivery intention.

It is easy to understand that, when the message 2 sent by the server 200 to the terminal device 100 includes marking information (for example, information such as the element and the text that need to be marked and that are related to the main delivery intention, and corresponding marking manners) of the element and the text that are related to the main delivery intention in the original advertisement picture-copy but does not include the original advertisement picture-copy, the terminal device 100 needs to perform marking in the displayed unmarked original advertisement picture-copy based on the marking information of the element and the text that are related to the main delivery intention in the original advertisement picture-copy, to generate and display the marked original advertisement picture-copy. A processing process is complex. Therefore, in some examples, the message 2 sent by the server 200 to the terminal device 100 may include the marked original advertisement picture-copy. In this way, the terminal device 100 may directly display the marked original advertisement picture-copy without performing additional processing.
S1011: The terminal device 100 detects an editing operation performed by the user on the marked original advertisement picture-copy.

Specifically, after the terminal device 100 displays the search result and the marked element and text that are related to the main delivery intention in the original advertisement picture-copy, the terminal device 100 may support the user in performing the editing operation on the original advertisement picture-copy based on a requirement of the user. The editing operation may include but is not limited to an operation of dragging the element in the search result to the original advertisement picture or an operation of removing the text segment from the original advertisement copy.

For example, when the element (for example, a circular element that is illustrated in FIG. 10F and that represents the wake-up intention) related to the incorrect/interfering delivery intention exists in the original advertisement picture, the terminal device 100 may support the user in selecting a candidate element (for example, the element related to the delivery intention set by the user or the delivery intention-unrelated element) from the search result, and dragging the candidate element (for example, a hexagonal element illustrated in FIG. 10G) to the original advertisement picture to cover the element related to the incorrect/interfering delivery intention. Optionally, the terminal device 100 may also support the user in manually adjusting a size of the element dragged to the original advertisement picture, so that the element related to the incorrect/interfering delivery intention can be completely blocked or the element can be integrally embedded in the original advertisement picture without affecting display of main advertisement content. The terminal device 100 may also support the user in directly selecting and removing the element related to the incorrect/interfering delivery intention from the original advertisement picture.

For example, when the original advertisement picture does not include the element related to the delivery intention set by the user, the terminal device 100 may support the user in selecting the element related to the delivery intention set by the user from the search result, and dragging the element to the original advertisement picture to supplement the element that is missing in the original advertisement picture and that is related to the delivery intention set by the user.

For example, when text (for example, the dark gray background-color text segment “Tap the circular icon to access the application” that is illustrated in FIG. 10F and that represents the wake-up intention) related to the incorrect/interfering delivery intention exists in the original advertisement copy, the terminal device 100 may support the user in selecting and removing the text related to the incorrect/interfering delivery intention in the original advertisement copy, to generate a new advertisement copy that does not include the text related to the incorrect/interfering delivery intention.

For example, when the original advertisement copy does not include text related to the delivery intention set by the user, the terminal device 100 may support the user in selecting candidate text related to the delivery intention set by the user, and dragging the candidate text to the original advertisement copy, to generate a new advertisement copy that includes the text related to the delivery intention set by the user. The candidate text may be sent by the server 200 to the terminal device 100, or may be locally stored in the terminal device 100. The candidate text may be presented in a copy candidate area (not shown in the figure) or the advertisement material display and interaction area in the interactive interface on the terminal device 100. This is not limited in embodiments of this application.

In some examples, the terminal device 100 may also display a cancel option (not shown in the figure). In this way, when the user is not satisfied with the editing operation on the original advertisement picture-copy, the user may tap the cancel option, so that the terminal device 100 returns to display the advertisement picture-copy before the editing operation.

In some examples, to help the user learn of a specific procedure of performing the editing operation on the advertisement picture-copy, before detecting the editing operation performed by the user on the marked original advertisement picture-copy, the terminal device 100 may display related prompt information used to guide the user to perform the editing operation.
S1012: The terminal device 100 sends a message 3 to the server 200, where the message includes information about the editing operation.

Specifically, after detecting the editing operation performed by the user on the marked original advertisement picture-copy, the terminal device 100 may send the message 3 to the server 200. The message includes the information about the editing operation, so that the server 200 may generate a new advertisement picture-copy based on the editing operation.

It should be noted that the foregoing step S1012 may be automatically triggered and performed by the terminal device 100 (for example, the foregoing step S1012 is automatically triggered and performed after the user completes the editing operation), or may be performed by the terminal device 100 through triggering by a user operation (for example, the terminal device 100 may display an option for sending the message 3 to the server 200, and the terminal device 100 may perform the foregoing step S1012 after detecting an operation of tapping the option by the user). This is not limited in embodiments of this application.
S1013: The server 200 generates the new advertisement picture-copy based on the message 3, and updates marks of a delivery intention-related element and delivery intention-related text in the new advertisement picture-copy.

Specifically, after receiving the message 3 sent by the terminal device 100, the server 200 may synthesize the new advertisement picture-copy based on the original advertisement picture-copy and the information about the editing operation included in the message 3, and update the marks of the delivery intention-related element and text in the new advertisement picture-copy.
S1014: The server 200 sends a message 4 to the terminal device 100, where the message includes information such as the new advertisement picture-copy and the marks of the delivery intention-related element and text in the new advertisement picture-copy.

Specifically, the server 200 may send a message 4 to the terminal device 100 after generating the new advertisement picture-copy and updating the marks of the delivery intention-related element and text in the new advertisement picture-copy. The message includes information such as the new advertisement picture-copy and the marks of the delivery intention-related element and text in the new advertisement picture-copy, so that the terminal device 100 can subsequently display the new advertisement picture-copy and the marks of the delivery intention-related element and text in the new advertisement picture-copy.
S1015: The terminal device 100 displays the new advertisement picture-copy and the marks of the delivery intention-related element and text in the new advertisement picture-copy based on the message 4.

Specifically, after receiving the message 4, the terminal device 100 may display the new advertisement picture-copy and the marks of the delivery intention-related element and text in the new advertisement picture-copy.

For example, with reference to FIG. 10G, the terminal device 100 may display, in the advertisement picture-copy display and interaction area, the new advertisement picture-copy (including a new advertisement picture 1031 and a new advertisement copy 1032) and the marks (for example, a gray mark of a rectangular element representing the form intention in the new advertisement picture 1031 and a gray background-color mark of the text segment “Fill in information in the rectangular form” representing the form intention in the new advertisement copy) of the delivery intention-related element and text in the new advertisement picture-copy. It can be learned that, compared with that in the original advertisement picture-copy shown in FIG. 10F, the new advertisement picture shown in FIG. 10G no longer includes the circular element representing the wake-up intention, and instead includes the delivery intention-unrelated element hexagon, and the new advertisement copy shown in FIG. 10G no longer includes the text segment “Tap the circular icon to access the application” representing the wake-up intention.

After the terminal device 100 displays the new advertisement picture-copy, if effect of the new advertisement picture-copy satisfies an expectation of the user, the terminal device 100 may support the user in exporting the new advertisement picture-copy (for example, the terminal device 100 may display an option for exporting the advertisement picture-copy, and the terminal device 100 may export the advertisement picture-copy after detecting an operation of tapping the option by the user). If the effect of the new advertisement picture-copy does not satisfy the expectation of the user, the foregoing steps S1011 to S1015 may be repeated until the effect of the new advertisement picture-copy satisfies the expectation of the user.

It is easy to understand that the exported new advertisement picture-copy may not include the marks of the delivery intention-related element and text. These marks may be manually deleted by the user before the user exports the new advertisement picture-copy, or may be automatically deleted by the terminal device 100 after the user triggers exporting of the new advertisement picture-copy.

In some examples, after detecting the editing operation performed by the user on the marked original advertisement picture-copy, the terminal device 100 may automatically generate and display the new advertisement picture-copy based on the editing operation, without participation of the server 200. In this case, the foregoing steps S1012 to S1015 may not be performed.

In this embodiment of this application, an example in which the method shown in FIG. 10A-1 and FIG. 10A-2 is jointly completed by the terminal device 100 and the server 200 is used. In some examples, the method shown in FIG. 10A-1 and FIG. 10A-2 may alternatively be independently completed by the terminal device 100 without participation of the server 200. It is easy to understand that, in this case, step S1006, step S1007, step S1008, and step S1013 in FIG. 10A-1 and FIG. 10A-2 may be performed by the terminal device 100, and interaction steps (for example, step S1005, step S1009, step S1012, and step S1014 in FIG. 10A-1 and FIG. 10A-2) between the terminal device 100 and the server 200 may be omitted.

Through implementation of the method shown in FIG. 10A-1 and FIG. 10A-2, the main delivery intention in the original advertisement picture-copy can be identified, and the element and the text that are related to the main delivery intention can be marked. Further, the interactive interface can be provided to guide. The user is visually guided to optimize the advertisement picture and the advertisement copy through the interactive interface, to suppress a misleading delivery intention in the advertisement picture-copy, and iteratively update the advertisement picture-copy. In this way, a user behavior guidance function implemented by the advertisement picture-copy matches the delivery intention set by the user (namely, the delivery intention specified by the advertiser), and the delivery intention set by the user can be clearly presented.

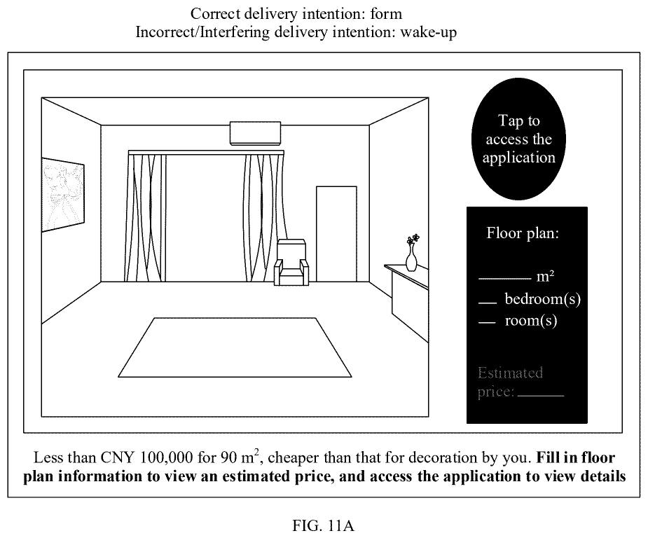

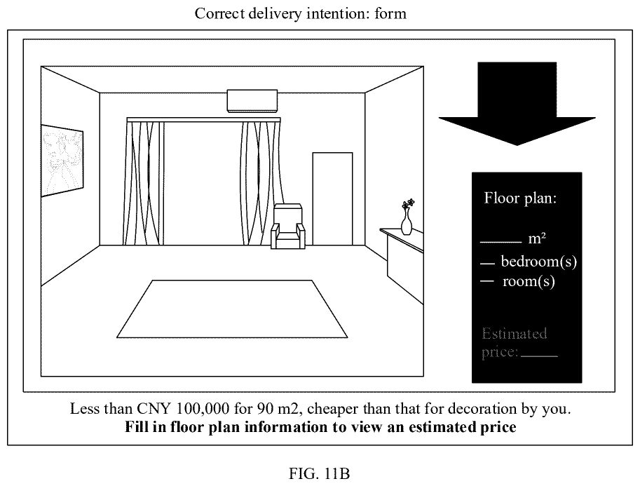

With reference to FIG. 11A and FIG. 11B, the following describes an example of a specific application scenario of performing delivery intention extraction on an original advertisement picture-copy to generate a new advertisement picture-copy.

A decoration advertisement delivery application scenario is used as an example. It is assumed that an advertisement picture-copy illustrated in FIG. 11A is the original advertisement picture-copy.

For example, it is assumed that a delivery intention (which may also be referred to as a correct delivery intention) set by a user is a form intention, and a system function set by the user is the delivery intention extraction. In this case, a generated new advertisement picture-copy may be, for example, an advertisement picture-copy illustrated in FIG. 11B. It can be learned from FIG. 11A that an incorrect/interfering delivery intention (namely, a delivery intention unrelated to the delivery intention set by the user) exists in the original advertisement picture-copy. For example, a wake-up intention-related element (for example, an option/button “Tap to access the application”) unrelated to the form intention exists in an original advertisement picture, and a wake-up intention-related text segment (for example, the text segment “Access the application to view details”) unrelated to the form intention exists in an original advertisement copy. After the delivery intention extraction is performed on the original advertisement picture, it can be learned from FIG. 11B that a delivery intention-unrelated element (for example, an arrow element in FIG. 11B) is embedded in the original advertisement picture to cover the wake-up intention-related element in the original advertisement picture, and the wake-up intention-related text segment is removed from the original advertisement copy. In this way, a misleading delivery intention in the advertisement picture-copy can be removed, and the delivery intention set by the user can be clearly presented.

It should be noted that the foregoing uses merely an example in which the delivery intention set by the user is the form intention to describe the specific application scenario in which the delivery intention extraction is performed on the original advertisement picture-copy to generate the new advertisement picture-copy. The delivery intention set by the user may alternatively be another delivery intention (for example, activation, next-day retention, payment, registration, or customization). This is not limited in embodiments of this application.

In this application, three system functions: the delivery intention embedding, the delivery intention correction, and the delivery intention extraction, may be all included, or only one or two of the three system functions may be included.

The following describes a possible manner of collaboration between an internal module of the terminal device 100 and an internal module of the server 200 in a process of performing an advertisement generation method provided in embodiments of this application.

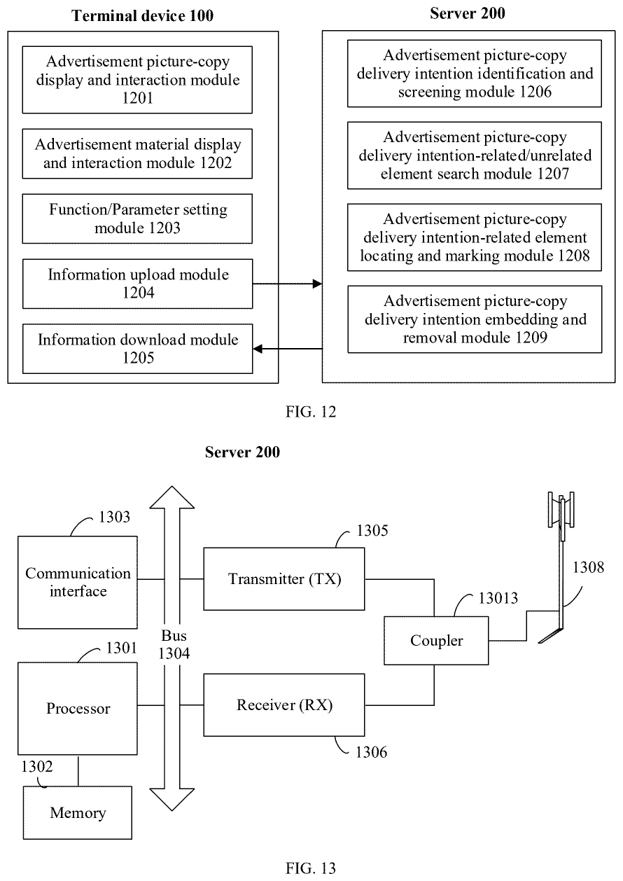

FIG. 12 illustrates a possible manner of collaboration between an internal module of the terminal device 100 and an internal module of the server 200 in a process of performing an advertisement generation method according to an embodiment of this application.

As shown in FIG. 12, the terminal device 100 may include an advertisement picture-copy display and interaction module 1201, an advertisement material display and interaction module 1202, a function/parameter setting module 1203, an information upload module 1204, and an information download module 1205. The server 200 may include an advertisement picture-copy delivery intention identification and screening module 1206, an advertisement picture-copy delivery intention-related/unrelated element search module 1207, an advertisement picture-copy delivery intention-related element locating and marking module 1208, and an advertisement picture-copy delivery intention embedding and removal module 1209.

The advertisement picture-copy display and interaction module 1201 may be configured to display an advertisement picture, an advertisement copy, and marks of a delivery intention-related element and delivery intention-related text, and the like; may be further configured to provide a user interaction function (for example, dragging an advertisement material to the advertisement picture-copy, adjusting a location/size of the advertisement material, or modifying the advertisement copy); and the like.

The advertisement material display and interaction module 1202 may be configured to display the advertisement material, a search result of a delivery intention-related element or unrelated element, a correlation coefficient corresponding to the delivery intention-related element, and the like; may be further configured to provide a user interaction function (for example, selecting the advertisement material or dragging the advertisement material to the advertisement picture-copy); and the like

The function/parameter setting module 1203 may be configured to provide a function/parameter setting interface, to support a user in setting a target delivery intention (for example, a delivery intention like wake-up, next-day retention, payment, activation, registration, a form, or customization) and selecting a system function (for example, a system function like delivery intention embedding, delivery intention correction, or delivery intention extraction) in the interface.

The information upload module 1204 may be configured to upload information about the advertisement picture-copy, information about an advertisement material library, information about a function/parameter setting, and the like to the server 200.

The information download module 1205 may be configured to download an optimized advertisement picture-copy (for example, an advertisement picture-copy obtained after the delivery intention embedding/correction/extraction is performed), the marks of the delivery intention-related element and text, the search result of the delivery intention-related element or unrelated element, and the like from the server 200.

The advertisement picture-copy delivery intention identification and screening module 1206 may be configured to identify a delivery intention represented in the advertisement picture and the advertisement copy in the advertisement picture-copy uploaded by the terminal device 100; may be further configured to screen a main delivery intention represented in the advertisement picture and the advertisement copy in the advertisement picture-copy uploaded by the terminal device 100; and the like.

The advertisement picture-copy delivery intention-related/unrelated element search module 1207 may be configured to search the advertisement material library (for example, an advertisement material library provided by an advertiser) for an element related to a delivery intention set by the user, the delivery intention-unrelated element, and the like.

The advertisement picture-copy delivery intention-related element locating and marking module 1208 may be configured to locate related elements that are of various delivery intentions represented in the advertisement picture-copy that are in the advertisement picture and related text segments of the various delivery intentions in the advertisement copy; may be further configured to mark the delivery intention-related element in the advertisement picture in a manner (for example, a heat map, a detection box, or a contour line); and may be further configured to mark the delivery intention-related text segment in the advertisement copy in a manner (for example, a word in a color, a text background color, or a detection box).

The advertisement picture-copy delivery intention embedding and removal module 1209 may be configured to embed, in an area of the advertisement picture, the element related to the delivery intention set by the user; may be further configured to embed the delivery intention-related/unrelated element in an area of the advertisement picture to cover an element related to an incorrect/interfering delivery intention in the advertisement picture; may be further configured to embed the delivery intention-related text segment in the advertisement copy; may be further configured to remove the element related to the incorrect/interfering delivery intention in the advertisement picture; may be further configured to remove the text segment related to the incorrect/interfering delivery intention in the advertisement copy; and the like.

In some examples, the server 200 may further include an information transceiver module (not shown in the figure). The information transceiver module may be configured to send information (for example, information such as the optimized advertisement picture-copy, the marks of the delivery intention-related element and text, and the search result of the delivery intention-related element or unrelated element) to another device (for example, the terminal device 100); and may be further configured to receive information (for example, information such as the advertisement picture-copy, the advertisement material library, and the function/parameter setting) sent by the another device (for example, the terminal device 100).

It is easy to understand that, when the advertisement generation method provided in this application is independently performed by the terminal device 100, the modules included in the server 200 may be integrated into the terminal device 100.

For more details about functions of the internal modules of the terminal device 100 and the server 200, refer to related content in the foregoing embodiments. Details are not described herein again.

It may be understood that the structure shown in FIG. 12 does not constitute a specific limitation on the terminal device 100 and the server 200. In some other embodiments of this application, the terminal device 100 and the server 200 may have more or fewer components than those shown in FIG. 12, or a combination of two or more components, or a configuration of different components. The components shown in the figure may be implemented in hardware including one or more signal processing and/or application-specific integrated circuits, software, or a combination of the hardware and software.

The following describes a structure of the server 200 provided in embodiments of this application.

FIG. 13 illustrates a structure of the server 200 according to an embodiment of this application.

As shown in FIG. 13, the server 200 may include one or more processors 1301, a memory 1302, a communication interface 1303, a transmitter 1305, a receiver 1306, a coupler 13013, and an antenna 1308. These components may be connected to each other through a bus 1304 or in another manner. In FIG. 13, an example in which these components are connected to each other through the bus is used.

The communication interface 1303 may be used by the server 200 to communicate with another device, for example, the terminal device 100. Specifically, the communication interface 1303 may be a 3G communication interface, a 4G communication interface, a 5G communication interface, a future new radio communication interface, or the like. In addition to a wireless communication interface, a wired communication interface, for example, a local access network (LAN) interface, may be further configured for the server 200. The transmitter 1305 may be configured to perform transmission processing on a signal output by the processor 1301. The receiver 1306 may be configured to perform receiving processing on a mobile communication signal received by the antenna 1308.

In some examples of this application, the transmitter 1305 and the receiver 1306 may be considered as a wireless modem. In the server 200, there may be one or more transmitters 1305 and receivers 1306. The antenna 1308 may be configured to convert electromagnetic energy in a transmission line into an electromagnetic wave in free space, or convert an electromagnetic wave in free space into electromagnetic energy in a transmission line. The coupler 13013 is configured to: divide a mobile communication signal received by the antenna 1308 into a plurality of signals, and allocate the plurality of signals to a plurality of receivers 1306.

The memory 1302 is coupled to the processor 1301, and is configured to store various software programs and/or a plurality of groups of instructions. Specifically, the memory 1302 may include a high-speed random access memory, and may further include a non-volatile memory, for example, one or more disk storage devices, a flash memory device, or another non-volatile solid-state storage device. The memory 1302 may store a network communication program. The network communication program may be used to communicate with one or more additional devices, one or more terminal devices, and one or more network devices.

In some examples of this application, the memory 1302 may be configured to store a program for implementing, on the server 200, the advertisement generation method provided in one or more embodiments of this application.

The processor 1301 may be configured to: read and execute computer-readable instructions. Specifically, the processor 1301 may be configured to: invoke a program stored in the memory 1302, for example, the program for implementing, on the server 200, the advertisement generation method provided in the one or more embodiments of this application, and execute instructions included in the program.

It should be noted that the server 200 shown in FIG. 13 is merely an implementation in embodiments of this application. During actual application, the server 200 may alternatively include more or fewer components. This is not limited herein.

For more details about a function and a working principle of the server 200, refer to related content in the foregoing embodiments. Details are not described herein again.

The following describes a diagram of a structure of the terminal device 100 provided in embodiments of this application.

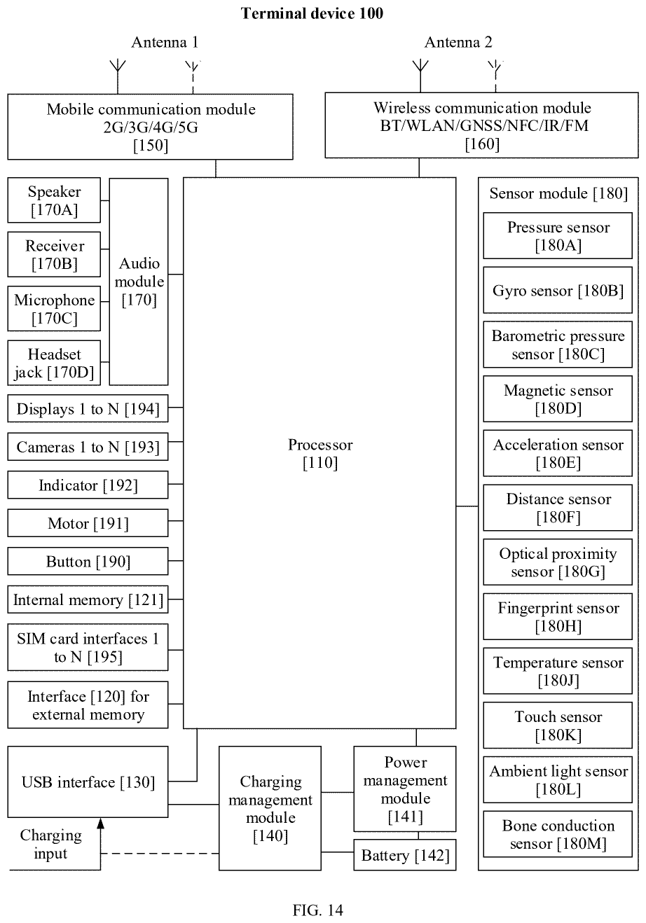

FIG. 14 illustrates a structure of the terminal device 100 according to an embodiment of this application.

As shown in FIG. 14, the terminal device 100 may include a processor 110, an interface 120 for external memory, an internal memory 121, a universal serial bus (USB) interface 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (SIM) card interface 195, and the like. The sensor module 180 may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It can be understood that the structure shown in this embodiment of this application does not constitute a specific limitation on the terminal device 100. In some other embodiments of this application, the terminal device 100 may include more or fewer components than those shown in the figure, or a combination of a part of the components, or splits from a part of the components, or an arrangement of different components. The components shown in the figure may be implemented by hardware, software, or a combination of the software and the hardware.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, and/or a neural-network processing unit (NPU). Different processing units may be independent devices, or may be integrated into one or more processors.

The controller may be a nerve center and a command center of the terminal device 100. The controller may generate an operation control signal based on an instruction operation code and a time sequence signal, to complete control of instruction fetching and instruction execution.

The memory may be further disposed in the processor 110, and is configured to store instructions and data. In some embodiments, the memory in the processor 110 is a cache. The memory may store instructions or data just used or cyclically used by the processor 110. If the processor 110 needs to use the instructions or the data again, the processor may directly invoke the instructions or the data from the memory. This avoids repeated access, and reduces a waiting time of the processor 110, thereby improving system efficiency.

In some examples of this application, the memory may be configured to store a program for implementing, on the terminal device 100, the advertisement generation method provided in one or more embodiments of this application.

The processor 110 may be configured to: read and execute computer-readable instructions. Specifically, the processor 110 may be configured to: invoke a program stored in the memory, for example, the program for implementing, on the terminal device 100, the advertisement generation method provided in the one or more embodiments of this application, and execute instructions included in the program.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identification module (SIM) interface, a universal serial bus (USB) interface, and/or the like.

The I2C interface is a two-way synchronization serial bus, and includes a serial data line (SDA) and a serial clock line (SCL). In some embodiments, the processor 110 may include a plurality of groups of I2C buses. The processor 110 may be separately coupled to the touch sensor 180K, a charger, a flash, the camera 193, and the like through different I2C bus interfaces. For example, the processor 110 may be coupled to the touch sensor 180K through the I2C interface, so that the processor 110 communicates with the touch sensor 180K through the I2C bus interface, to implement a touch function of the terminal device 100.

The I2S interface may be configured to perform audio communication. In some embodiments, the processor 110 may include a plurality of groups of I2S buses. The processor 110 may be coupled to the audio module 170 through the I2S bus, to implement communication between the processor 110 and the audio module 170. In some embodiments, the audio module 170 may transmit an audio signal to the wireless communication module 160 through the I2S interface, to implement a function of answering a call through a Bluetooth headset.

The PCM interface may also be configured to: perform audio communication, and sample, quantize, and encode an analog signal. In some embodiments, the audio module 170 may be coupled to the wireless communication module 160 through a PCM bus interface. In some embodiments, the audio module 170 may alternatively transmit an audio signal to the wireless communication module 160 through the PCM interface, to implement a function of answering a call through a Bluetooth headset. Both the I2S interface and the PCM interface may be configured to perform audio communication.

The UART interface is a universal serial data bus, and is configured to perform asynchronous communication. The bus may be a two-way communication bus. The bus converts to-be-transmitted data between serial communication and parallel communication. In some embodiments, the UART interface is generally configured to connect the processor 110 to the wireless communication module 160. For example, the processor 110 communicates with a Bluetooth module in the wireless communication module 160 through the UART interface, to implement a Bluetooth function. In some embodiments, the audio module 170 may transmit an audio signal to the wireless communication module 160 through the UART interface, to implement a function of playing music through a Bluetooth headset.

The MIPI interface may be configured to connect the processor 110 to a peripheral device like the display 194 or the camera 193. The MIPI interface includes a camera serial interface (CSI), a display serial interface (DSI), and the like. In some embodiments, the processor 110 communicates with the camera 193 through the CSI interface, to implement a photographing function of the terminal device 100. The processor 110 communicates with the display 194 through the DSI interface, to implement a display function of the terminal device 100.

The GPIO interface may be configured by software. The GPIO interface may be configured as a control signal or a data signal. In some embodiments, the GPIO interface may be configured to connect the processor 110 to the camera 193, the display 194, the wireless communication module 160, the audio module 170, the sensor module 180, or the like. The GPIO interface may alternatively be configured as an I2C interface, an I2S interface, a UART interface, an MIPI interface, or the like.

The USB interface 130 is an interface that conforms to a USB standard specification, and may be specifically a mini USB interface, a micro USB interface, a USB type-C interface, or the like. The USB interface 130 may be configured to connect to a charger to charge the terminal device 100, may be configured to transmit data between the terminal device 100 and a peripheral device, or may be configured to connect to a headset, to play an audio through the headset. The interface may alternatively be configured to connect to another terminal device, for example, an AR device.

It may be understood that an interface connection relationship between the modules shown in this embodiment of this application is merely an example for description, and does not constitute a limitation on the structure of the terminal device 100. In some other embodiments of this application, the terminal device 100 may alternatively use an interface connection manner different from that in the foregoing embodiment, or a combination of a plurality of interface connection manners.

The charging management module 140 is configured to receive a charging input from a charger. The charger may be a wireless charger or a wired charger. In some embodiments of wired charging, the charging management module 140 may receive a charging input from a wired charger through the USB interface 130. In some embodiments of wireless charging, the charging management module 140 may receive a wireless charging input through a wireless charging coil of the terminal device 100. When charging the battery 142, the charging management module 140 may further supply power to the terminal device 100 through the power management module 141.

The power management module 141 is configured to connect to the battery 142, the charging management module 140, and the processor 110. The power management module 141 receives inputs/an input of the battery 142 and/or the charging management module 140, to supply power to the processor 110, the internal memory 121, an external memory, the display 194, the camera 193, the wireless communication module 160, and the like. The power management module 141 may be further configured to monitor parameters such as a battery capacity, a battery cycle count, and a battery health status (electric leakage and impedance). In some other embodiments, the power management module 141 may alternatively be disposed in the processor 110. In some other embodiments, the power management module 141 and the charging management module 140 may alternatively be disposed in a same device.

A wireless communication function of the terminal device 100 may be implemented through the antenna 1, the antenna 2, the mobile communication module 150, the wireless communication module 160, the modem processor, the baseband processor, and the like.

The antenna 1 and the antenna 2 are configured to transmit and receive electromagnetic wave signals. Each antenna in the terminal device 100 may be configured to cover one or more communication frequency bands. Different antennas may be further reused, to improve antenna utilization. For example, the antenna 1 may be reused as a diversity antenna of a wireless local area network. In some other embodiments, the antenna may be used in combination with a tuning switch.

The mobile communication module 150 may provide a solution that is applied to the terminal device 100 and that includes wireless communication such as 2G, 3G, 4G, and 5G. The mobile communication module 150 may include at least one filter, a switch, a power amplifier, a low noise amplifier (LNA), and the like. The mobile communication module 150 may receive an electromagnetic wave through the antenna 1, perform processing like filtering or amplification on the received electromagnetic wave, and transmit a processed electromagnetic wave to the modem processor for demodulation. The mobile communication module 150 may further amplify a signal modulated by the modem processor, and convert the signal into an electromagnetic wave for radiation through the antenna 1. In some embodiments, at least a part of functional modules of the mobile communication module 150 may be disposed in the processor 110. In some embodiments, at least a part of the functional modules of the mobile communication module 150 may be disposed in a same device as at least a part of modules of the processor 110.

The modem processor may include a modulator and a demodulator. The modulator is configured to modulate a to-be-sent low-frequency baseband signal into a medium/high-frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor, and then transmitted to the application processor. The application processor outputs a sound signal through an audio device (which is not limited to the speaker 170A, the receiver 170B, and the like), or displays an image or a video through the display 194. In some embodiments, the modem processor may be an independent device. In some other embodiments, the modem processor may be independent of the processor 110, and is disposed in a same device as the mobile communication module 150 or another functional module.

The wireless communication module 160 may provide a solution that is applied to the terminal device 100 and that includes wireless communication such as a wireless local area network (WLAN) (for example, a wireless fidelity (Wi-Fi) network), Bluetooth (BT), a global navigation satellite system GNSS), frequency modulation (FM), near field communication (NFC), and an infrared (i IR) technology. The wireless communication module 160 may be one or more devices integrating at least one communication processing module. The wireless communication module 160 receives an electromagnetic wave through the antenna 2, performs frequency modulation and filtering processing on an electromagnetic wave signal, and sends a processed signal to the processor 110. The wireless communication module 160 may further receive a to-be-sent signal from the processor 110, perform frequency modulation and amplification on the to-be-sent signal, and convert a processed signal into an electromagnetic wave for radiation through the antenna 2.

In some embodiments, in the terminal device 100, the antenna 1 is coupled to the mobile communication module 150, and the antenna 2 is coupled to the wireless communication module 160, so that the terminal device 100 can communicate with a network and another device using a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite based augmentation system (SBAS).

The terminal device 100 implements a display function through the GPU, the display 194, the application processor, and the like. The GPU is a microprocessor for image processing, and is connected to the display 194 and the application processor. The GPU is configured to: perform mathematical and geometric computation, and render an image. The processor 110 may include one or more GPUs, and execute program instructions to generate or change display information.

The display 194 is configured to display an image, a video, and the like. The display 194 includes a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the terminal device 100 may include one or N displays 194, where N is a positive integer greater than 1.

The terminal device 100 may implement a photographing function through the ISP, the camera 193, the video codec, the GPU, the display 194, the application processor, and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, brightness, and the like of the image. The ISP may further optimize parameters such as exposure and a color temperature of a photographing scene. In some embodiments, the ISP may be disposed in the camera 193.

The camera 193 is configured to capture a static image or a video. An optical image of an object is generated through a lens, and is projected to a photosensitive element. The photosensitive element may be a charge coupled device (CCD) or a complementary metal-oxide-semiconductor (CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format like RGB or YUV. In some embodiments, the terminal device 100 may include one or N cameras 193, where N is a positive integer greater than 1.

The digital signal processor is configured to process a digital signal, and may further process another digital signal in addition to the digital image signal. For example, when the terminal device 100 selects a frequency, the digital signal processor is configured to perform Fourier transform on frequency energy.

The video codec is configured to compress or decompress a digital video. The terminal device 100 may support one or more video codecs. In this way, the terminal device 100 can play or record videos in a plurality of encoding formats, for example, moving picture experts group (MPEG)-1, MPEG-2, MPEG-3, and MPEG-4.

The NPU is a neural-network (NN) computing processor, quickly processes input information by referring to a structure of a biological neural network, for example, by referring to a mode of transfer between human brain neurons, and may further continuously perform self-learning. Applications such as intelligent cognition of the terminal device 100, for example, image recognition, facial recognition, speech recognition, and text understanding, may be implemented through the NPU.

The interface 120 for external memory may be configured to connect to an external memory card, for example, a micro SD card, to extend a storage capability of the terminal device 100. The external memory card communicates with the processor 110 through the interface 120 for external memory, to implement a data storage function. For example, files such as music and a video are stored in the external memory card.

The internal memory 121 may be configured to store computer-executable program code. The executable program code includes instructions. The processor 110 runs the instructions stored in the internal memory 121, to perform various function applications of the terminal device 100 and data processing. The internal memory 121 may include a program storage area and a data storage area. The program storage area may store an operating system, an application required by at least one function (for example, a sound playing function or an image playing function), and the like. The data storage area may store data (for example, audio data or a phone book) created in a process of using the terminal device 100, and the like. In addition, the internal memory 121 may include a high-speed random access memory, and may further include a non-volatile memory, for example, at least one magnetic disk storage device, a flash memory device, or a universal flash storage (UFS).

The terminal device 100 may implement an audio function, for example, music playing or recording, through the audio module 170, the speaker 170A, the receiver 170B, the microphone 170C, the headset jack 170D, the application processor, and the like.

The audio module 170 is configured to convert digital audio information into an analog audio signal for output, and is also configured to convert analog audio input into a digital audio signal. The audio module 170 may be further configured to: encode and decode audio signals. In some embodiments, the audio module 170 may be disposed in the processor 110, or a part of functional modules of the audio module 170 are disposed in the processor 110.

The speaker 170A, also referred to as a “loudspeaker”, is configured to convert an audio electrical signal into a sound signal. The terminal device 100 may be configured to listen to music or answer a call in a hands-free mode through the speaker 170A.

The receiver 170B, also referred to as an “earpiece”, is configured to convert an audio electrical signal into a sound signal. When a call is answered or voice information is listened to through the terminal device 100, the receiver 170B may be put close to a human ear to listen to a voice.

The microphone 170C, also referred to as a “mike” or a “mic”, is configured to convert a sound signal into an electrical signal. When making a call or sending voice information, a user may make a sound near the microphone 170C through the mouth of the user, to input a sound signal into the microphone 170C. At least one microphone 170C may be disposed in the terminal device 100. In some other embodiments, two microphones 170C may be disposed in the terminal device 100, to implement a noise reduction function in addition to collecting a sound signal. In some other embodiments, three, four, or more microphones 170C may alternatively be disposed in the terminal device 100, to collect a sound signal, implement noise reduction, and identify a sound source, to implement a directional recording function, and the like.

The headset jack 170D is configured to connect to a wired headset. The headset jack 170D may be a USB interface 130, or may be a 3.5 mm open mobile terminal platform (OMTP) standard interface, or a cellular telecommunications industry association of the USA (CTIA) standard interface.

The pressure sensor 180A is configured to sense a pressure signal, and can convert the pressure signal into an electrical signal. In some embodiments, the pressure sensor 180A may be disposed on the display 194. There are a plurality of types of pressure sensors 180A, for example, a resistive pressure sensor, an inductive pressure sensor, and a capacitive pressure sensor. The capacitive pressure sensor may include at least two parallel plates made of a conductive material. When a force is applied to the pressure sensor 180A, capacitance between electrodes changes. The terminal device 100 determines pressure intensity based on a capacitance change. When a touch operation is performed on the display 194, the terminal device 100 detects intensity of the touch operation through the pressure sensor 180A. The terminal device 100 may also calculate a touch location based on a detection signal of the pressure sensor 180A. In some embodiments, touch operations that are performed on a same touch location but have different touch operation intensity may correspond to different operation instructions. For example, when a touch operation whose touch operation intensity is less than a first pressure threshold is performed on an SMS message application icon, an instruction for viewing an SMS message is performed. When a touch operation whose touch operation intensity is greater than or equal to the first pressure threshold is performed on the SMS message application icon, an instruction for creating a new SMS message is performed.

The touch sensor 180K is also referred to as a “touch panel”. The touch sensor 180K may be disposed on the display 194, and the touch sensor 180K and the display 194 form a touchscreen that is also referred to as a “touch screen”. The touch sensor 180K is configured to detect a touch operation performed on or near the touch sensor. The touch sensor may transfer the detected touch operation to the application processor, to determine a type of the touch event. A visual output related to the touch operation may be provided through the display 194. In some other embodiments, the touch sensor 180K may alternatively be disposed on a surface of the terminal device 100 at a location different from that of the display 194.

The button 190 includes a power button, a volume button, and the like. The button 190 may be a mechanical button, or a touch button. The terminal device 100 may receive a button input, and generate a button signal input related to a user setting and function control of the terminal device 100.

The motor 191 may generate a vibration prompt. The motor 191 may be configured to provide an incoming call vibration prompt and a touch vibration feedback. For example, touch operations performed on different applications (for example, a photographing application and an audio playing application) may correspond to different vibration feedback effect. The motor 191 may also correspond to different vibration feedback effect for touch operations performed on different areas of the display 194. Different application scenarios (for example, a time reminder, information receiving, an alarm clock, and a game) may also correspond to different vibration feedback effect. Touch vibration feedback effect may be further customized.

The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the terminal device 100. The terminal device 100 may support one or N SIM card interfaces, where N is a positive integer greater than 1. The SIM card interface 195 can support a nano-SIM card, a micro-SIM card, a SIM card, and the like. A plurality of cards may be simultaneously inserted into a same SIM card interface 195. The plurality of cards may be of a same type or different types. The SIM card interface 195 may be compatible with different types of SIM cards. The SIM card interface 195 is also compatible with an external memory card. The terminal device 100 interacts with a network through the SIM card, to implement functions such as calling and data communication. In some embodiments, the terminal device 100 uses an eSIM, namely, an embedded SIM card. The eSIM card may be embedded in the terminal device 100, and cannot be separated from the terminal device 100.

It should be understood that the terminal device 100 shown in FIG. 14 is merely an example, and the terminal device 100 may have more or fewer components than those shown in FIG. 14, or a combination of two or more components, or a configuration of different components. The components shown in FIG. 14 may be implemented in hardware including one or more signal processing and/or application-specific integrated circuits, software, or a combination of the hardware and software.

The foregoing embodiments may be all or partially implemented using software, hardware, firmware, or any combination thereof. When being implemented using the software, the foregoing embodiments may be all or partially implemented in a manner of a computer program product. The computer program product includes one or more computer instructions. When the computer instructions are loaded and executed on a computer, the procedure or functions according to this application are all or partially generated. The computer may be a general-purpose computer, a dedicated computer, a computer network, or another programmable apparatus. The computer instructions may be stored in a computer-readable storage medium or transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, or microwave) manner. The computer-readable storage medium may be any usable medium accessible by a computer, or a data storage device like a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

Persons of ordinary skill in the art may understand that all or a part of the procedures of the methods in embodiments may be implemented by a computer program instructing related hardware. The program may be stored in a computer-readable storage medium. When the program is run, the procedures of the methods in embodiments may be included. The foregoing storage medium includes any medium that can store program code, for example, a ROM, a random access memory RAM, a magnetic disk, or an optical disc.

The foregoing embodiments are intended merely to describe the technical solutions in this application, but not to limit the technical solutions. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions in embodiments of this application.

What is claimed is:

1. An advertisement generation method, comprising:
displaying, by a terminal device, a first advertisement in a first user interface;
detecting, by the terminal device, a first user operation in the first user interface;
obtaining, by the terminal device, a first delivery intention of the first advertisement in response to the first user operation; and
displaying, by the terminal device, a second advertisement in the first user interface, wherein the second advertisement is generated by embedding a first interface element in the first advertisement, the first interface element determined based on the first delivery intention, and the first interface element is used to receive a second user operation.

2. The method according to claim 1, wherein the terminal device stores a first advertisement material library, and the first interface element is obtained from the first advertisement material library.

3. The method according to claim 1, wherein the first interface element comprises one of a picture control, a word control, a form control, and an icon control.

4. The method according to claim 1, wherein the first delivery intention comprises one of wake-up, next-day retention, payment, activation, registration, a form, and customization.

5. The method according to claim 1, wherein the first advertisement comprises a first advertisement copy, the second advertisement comprises a second advertisement copy, the second advertisement copy is generated by embedding first text in the first advertisement copy, and the first text is determined based on the first delivery intention.

6. The method according to claim 1, wherein the first interface element is embedded in a blank area in the first advertisement that does not comprise another interface element.

7. The method according to claim 1, wherein before displaying, by the terminal device, the second advertisement in the first user interface, the method further comprises:
sending, by the terminal device, a first message to a server, wherein the first message is used by the server to generate the second advertisement based on the first advertisement and the first delivery intention; and
receiving, by the terminal device, a second message sent by the server, wherein the second message comprises information about the second advertisement,
wherein displaying, by the terminal device, the second advertisement in the first user interface comprises:
displaying, by the terminal device, the second advertisement in the first user interface based on the information about the second advertisement.

8. The method according to claim 1, wherein the first advertisement further comprises a second interface element and a third interface element, the second interface element is different from the third interface element, and the method further comprises:
detecting, by the terminal device, a third user operation in the first user interface;
obtaining, by the terminal device, a second delivery intention of the first advertisement in response to the third user operation; and
displaying, by the terminal device, a third advertisement in the first user interface, wherein the third advertisement is distinct from the second interface element, the third advertisement is generated after the second interface element is removed from the first advertisement or after the second interface element is replaced with a fourth interface element in the first advertisement, the second interface element is unrelated to the second delivery intention, the third interface element is related to the second delivery intention, and the third interface element is used to receive a fourth user operation.

9. The method according to claim 8, further comprising:
embedding, by the terminal device based on a user selection operation, the fourth interface element in an area in which the second interface element is located.

10. The method according to claim 9, wherein embedding, by the terminal device based on the user selection operation, the fourth interface element in the area in which the second interface element is located comprises:
displaying, by the terminal device, a second advertisement material library in the first user interface, wherein the second advertisement material library comprises one or more interface elements, and the one or more interface elements comprise the fourth interface element; and
dragging, by the terminal device based on the user selection operation, the fourth interface element from the second advertisement material library to the area in which the second interface element is located.

11. The method according to claim 8, wherein a first advertisement copy comprises second text and third text, the second text is unrelated to the second delivery intention, the third text is related to the second delivery intention, the third advertisement comprises a third advertisement copy, and the third advertisement copy is generated after the second text is removed from the first advertisement copy.

12. The method according to claim 11, wherein a display manner of the second text is different from a display manner of the third text.

13. The method according to claim 8, wherein a display manner of the second interface element is different from a display manner of the third interface element.

14. The method according to claim 1, wherein the first advertisement comprises a fifth interface element, and the method further comprises:
detecting, by the terminal device, a fifth user operation in the first user interface;
obtaining, by the terminal device, a third delivery intention of the first advertisement in response to the fifth user operation; and
displaying, by the terminal device, a fourth advertisement in the first user interface, wherein the fourth advertisement is generated after the fifth interface element is replaced with a sixth interface element in the first advertisement, the sixth interface element is determined based on the third delivery intention, and the sixth interface element is used to receive a sixth user operation.

15. The method according to claim 14, wherein the sixth interface element is obtained from a first advertisement material library.

16. The method according to claim 14, wherein a first advertisement copy comprises a fourth text, the fourth text is unrelated to the third delivery intention, the fourth advertisement comprises a fourth advertisement copy, the fourth advertisement copy is generated after the fourth text is removed from and fifth text is embedded in the first advertisement copy, and the fifth text is determined based on the third delivery intention.

17. An electronic device, comprising:
at least one processor; and
one or more memories coupled to the at least one processor storing computer program code, the computer program code comprised of computer instructions, wherein when the at least one processor executes the computer instructions, the electronic device is caused to:
display a first advertisement in a first user interface;
detect a first user operation in the first user interface;
obtain a first delivery intention of the first advertisement in response to the first user operation; and
display a second advertisement in the first user interface, wherein the second advertisement is generated by embedding a first interface element in the first advertisement, the first interface element determined based on the first delivery intention, and the first interface element is used to receive a second user operation.

18. The electronic device according to claim 17, wherein the first interface element comprises one of a picture control, a word control, a form control, and an icon control.

19. The electronic device according to claim 17, wherein the first delivery intention comprises one of wake-up, next-day retention, payment, activation, registration, a form, and customization.

20. A non-transitory computer storage medium, wherein the computer storage medium stores a computer program, the computer program comprises program instructions that, when executed by at least one processor, cause the at least one processor to:
display, on a device display, a first advertisement in a first user interface;
detect a first user operation in the first user interface;
obtain a first delivery intention of the first advertisement in response to the first user operation; and
display, on the display device, a second advertisement in the first user interface, wherein the second advertisement is generated by embedding a first interface element in the first advertisement, the first interface element determined based on the first delivery intention, and the first interface element is used to receive a second user operation.
